(19) United States
(12) Patent Application Publication
(10) Pub. No.: US 2014/0162240 A1
(43) Pub. Date: Jun. 12, 2014

(54) ASSESSMENT METHOD AND APPARATUS

(71) Applicant: Bliip IP Pty Ltd, Sheldon (AU)

(72) Inventors: Antony Vincent WHEELER,, Sheldon QLD (AU); Sally-Ann LAUDER, Bowen Hills (AU)

(73) Assignee: Bliip IP Pty Ltd, Sheldon (AU)

(21) Appl. No.: 13/933,373

(22) Filed: Jul. 2, 2013

(30) Foreign Application Priority Data
Jul. 2, 2012 (AU) 2012902812
May 14, 2013 (AU) 2013205850

(51) Int. Cl. G09B 7/00

(52) U.S. Cl. CPC G09B 7/00
USPC 434/362

(57) ABSTRACT

Apparatus for use in performing an employability skills assessment for assessing employability skills of an assessee, the apparatus including an electronic processing device that identifies at least one rater in accordance with input commands from an assessee, transfers a number of questions to the at least one rater via a communications network, the questions relating to employability skills of the assessee, receives responses to the number of questions from the at least one rater via a communications network and determines an employability skills rating at least partially using the responses, the employability skills rating being at least partially indicative of the assessee's employability skills.

### CROSS-REFERENCE TO RELATED APPLICATIONS

This application claims priority to Australian Patent Application No. 2012902812 filed 2 Jul. 2012 and Australian Patent Application No. 2013205850 filed 14 May 2013 the disclosures of which are incorporated in their entirety by reference herein.

### BACKGROUND OF THE INVENTION

The present invention relates to a method and apparatus for use in performing an employability skills assessment for assessing employability skills of an assessee.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

The selection of candidates for employment can be a time consuming and expensive process and although there are many psychometric and other tests available, they are limited in their capacity to predict a person's performance in their job.

The process of applying for a position of employment, when you have limited work experience (eg High School or University Graduate) can be very challenging, with limited opportunity to demonstrate your broader skill base (often referred to as ‘life skills’) and their transferability to a new environment.

Whilst industry employers and researchers have attempted to identify a set of ‘employability skills’ (also known by other names in different countries, for example, but not limited to, labour skills, future skills, job ready skills, core skills) that they consider important when recruiting new staff, there are often different views on what constitute employability skills meaning there is no job market wide, or even industry wide accepted definition that can be used consistently. Additionally, there are few if any formalised processes for assessing such skills. At best assessment of employability skills is typically only performed by potential employers on an ad-hoc basis, for example by running workshops for potential applicants. This is of only limited use and potential employees only have a limited opportunity to demonstrate their knowledge. Additionally, this is an extremely inefficient process, with many users having to undergo repeated assessment, for example when applying for multiple jobs.

It is also known that most forms of assessment are based on self-reporting by an applicant. A system known to be inherently biased and flawed as a predictor of performance, and known to have limited credibility in industry.

Furthermore, whilst the education system is currently assuming increasing responsibility for the production of ‘work ready’ graduates (at all levels of education) there is no method for the assessment of employability skills and the identification of appropriate development paths/programs.

As a result, assessment of such skills for potential employees is not widely used and employers are left perpetually frustrated at knowing that skills and qualifications only represent part of the picture in recruitment, and that employability skills are equally, if not in many cases more valid, but have no easy mechanism for assessing these.

Accordingly, there is a need to improve assessment of employability skills for a wide range of scenarios, including for job applicant, employers, educators and trainers.

### SUMMARY OF THE PRESENT INVENTION

In a first broad form the present invention seeks to provide apparatus for use in performing an employability skills assessment for assessing employability skills of an assessee, the apparatus including an electronic processing device that:
a) identifies at least one rater in accordance with input commands from an assessee;
b) transfers a number of questions to the at least one rater via a communications network, the questions relating to employability skills of the assessee;
c) receives responses to the number of questions from the at least one rater via a communications network; and,
d) determines an employability skills rating at least partially using the responses, the employability skills rating being at least partially indicative of the assessee's employability skills.

Typically the electronic processing device selects the number of questions from a plurality of predefined questions stored in a store.

Typically the electronic processing device:
a) determines selection of at least one question category in accordance with input commands from an assessee; and,
b) selects the number of questions in accordance with the at least one question category.

Typically the electronic processing device:
a) causes details of available surveys to be displayed to the assessee; and,
b) determines selection of an available survey in accordance with input commands from the assessee.

Typically at least one question relates to at least one of:
a) skills of the assessee;
b) attributes of the assessee;
c) an industry;
d) a role for the assessee;
e) education of the assessee;
f) employability skills; and,
g) industry specific skills.

Typically the electronic processing device:
a) transfers a number of questions to the assessee via a communications network;
b) receives responses to the number of questions from the assessee via a communications network; and,
c) determines an employability skills rating at least partially using the responses.

Typically the electronic processing device generates an indication of the employability skills rating.

Typically the electronic processing device provides the indication of the employability skills rating via a communications network.

Typically the electronic processing device provides the indication of the employability skills rating to at least one of:
a) the assessee;
b) one or more raters;
c) a server of a social media network; and,
d) a potential assessor.

Typically the electronic processing device:
a) determines at least one rating value for the assessee using the responses; and,
b) generates the indication of the employability skills rating at least partially in accordance with the rating value.

Typically at least one of the questions includes a number of predetermined response options, each response option having a respective associated rating value, and wherein the electronic processing device determines the employability skills rating at least in part based on the selected response option and the associated rating value.

Typically the employability skills rating is determined based on at least one of:
a) an average response of each rater;
b) a highest response of each rater;
c) a lowest response of each rater; and,
d) a response of each rater in a group of raters.

Typically the raters are grouped according to a rater type, and wherein the method includes, in the electronic processing device, determining a respective employability skills rating for each group of raters.

Typically the electronic processing device generates a report including at least one of:
a) the indication of the employability skills rating;
b) responses of at least one of the assessee and at least one rater;
c) a comparison of responses of the assessee and at least one rater;
d) a comparison of a first employability skills rating based on assessee responses and a second employability skills rating based on rater responses; and,
e) an indication of an identity of at least one rater.

Typically the indication of the employability skills rating includes at least one of a graphical and an alphanumeric representation of at least one rating value.

Typically the report includes an indicator displaying an employability skills rating for at least one of:
a) a cluster of categories; and,
b) a category.

Typically the indicator includes at least one of:
a) a category indication identifying a respective category;
b) for each of a number of groups of raters:
   i) a rater number identifying a number of raters in the respective group;
   ii) a group identifier identifying the respective group;
   iii) a first bar indicating the average rating of the respective group; and,
   iv) a second bar highlighting the highest and lowest rating of the group; and,
c) an assessee rating.

Typically the electronic processing device generates a reminder in the event that responses to the questions have not been received after a predetermined time interval.

Typically the electronic processing device:
a) determines if responses have not been received from a rater after a predetermined number of reminders; and,
b) determines an alternative rater in accordance with input commands from the assessee.

Typically for each rater the assessee provides contact details allowing the electronic processing device to transfer questions via the communications network.

Typically the questions are grouped in categories and clusters of categories.

Typically the clusters of categories include:
a) Personal Attributes;
b) Working with Others;
c) Achieving at Work;
d) Future Skills; and
e) Learning.

Typically the personal attributes cluster includes categories relating to:
a) honesty/integrity;
b) social responsibility;
c) motivation/enthusiasm;
d) positive attitude;
e) resilience;
f) self-awareness/self-management;
g) reliability/responsibility;
h) autonomy/independence; and,
i) personal presentation.

Typically the Working with Others cluster includes categories relating to:
a) communicating with others;
b) leading and influence;
c) respect for diversity;
d) team/group outcomes;
e) engaging networks;
f) connectivity/social intelligence; and
g) conflict resolution.

Typically the Achieving at Work cluster includes categories relating to:
a) professionalism/work ethic;
b) customer service;
c) written communication;
d) numeracy;
e) using tools and technology;
f) critical thinking/problem solving;
g) understanding context of work;
h) working safely;
i) finding and managing information;
j) planning, organising and implementing; and,
k) delivering results.

Typically the Future Skills cluster includes categories relating to:
a) technical competency;
b) media communication;
c) information analysis capabilities;
d) navigating trends and choices;
e) design mindset;
f) connection and collaboration;
g) being a global citizen;
h) personal mastery; and
i) career architect.

Typically the Learning Skills cluster includes categories relating to:
a) learning at work;
b) adaptability;
c) flexibility; and
d) lifelong learning.

In a second broad form the present invention seeks to provide a method for use in performing an employability skills assessment for assessing employability skills of an assessee, the method including in an electronic processing device:
a) identifying at least one rater in accordance with input commands from an assessee;
b) transferring a number of questions to the at least one rater via a communications network, the questions relating to employability skills of the assessee;
c) receiving responses to the number of questions from the at least one rater via a communications network; and,
d) determining an employability skills rating at least partially using the responses, the employability skills rating being at least partially indicative of the assessee's employability skills.

In a third broad form the present invention seeks to provide a computer based method and apparatus for defining, standardising, and measuring multiple-perspectives and reporting on generic and industry specific employability skills of a potential employee for a potential employer.

In a fourth broad form the present invention seeks to provide a computer implemented method of an assessment of a job assessee, the assessment being against an electronic data store of a plurality of categories and questions for generic and industry specific employability skills, the method comprising of:
a) Storing in an electronic data store a plurality of questions designed to assess an assessees' generic and/or industry specific employability skills and attributes, with the questions created and stored based on a plurality of criteria including educational standing and industry;
b) Providing an assessee the option to choose a generic or industry specific questionnaire/survey, subsequently populated from the plurality of questions, subject to the assessee chosen educational and industry field;
c) Providing an assessee, via means of a computer based GUI, a series of randomly sequenced questions drawn from the electronic data store based on the assessee's choice of educational and industry level;
d) Providing an assessee a means, via GUI, of indicating their own self-assessment against the questions, for storing, recording and later recalling;
e) Providing an assessee a means of selecting a group of raters whom to gain feedback from, via a method of raters completing the same survey as the assessee, on the assessee, therein providing an external perspective of the assessees employability skills against the aforementioned questions;
f) Providing the raters with the same series of randomly generated questions as for the assessee, for them to independently answer;
g) Providing a means of generating a report in hard copy or multi-media format, that provides a comparison of answers between the assessee and the raters, grouped by cohorts of raters.

Typically the plurality of different categories and questions relates to the specific skills and attributes of generic or industry specific employability;

Typically the method includes having the assessee complete the assessment before the raters complete the assessment.

Typically cohorts of raters comprise groupings of like relationships to the assessee for example but not limited to, family, employer, coach, manager, staff member.

Typically upon completion, a report is generated that allows an assessee to assess their own answers against those of the raters.

Typically a report is generated using quantifiers based upon calculations of:
a) an average of all responses of raters for each cohort;
b) a highest response for a given cohort of raters;
c) a lowest response for a given cohort of raters;
d) an average of all responses of raters for each cohort aggregated up to a level of clusters, a superordinate summation of all categories.

Typically the apparatus contains:
a) a display for visually displaying to the assessee each of the question types and requesting the assessee to indicate their answer to each question;
b) an input means for allowing the assessee to indicate their answers; and
c) a processor for driving the display and for being responsive to the input device for determining the answer provided by the assessee.

In a fifth broad form the present invention seeks to provide a computer and apparatus based method and apparatus for measuring and reporting on global generic and industry specific employability skills of a potential employee for a potential employer sorted by a plurality of demographic qualifiers collected through the accumulation, storage and retrieval of all responses from the sum total of all users/assessees and raters of the method of any one of the other broad forms of the invention.

It will be appreciated that the broad forms of the invention may be used individually or in combination.

### BRIEF DESCRIPTION OF THE DRAWINGS

An example of the present invention will now be described with reference to the accompanying drawings, in which:—

FIG. 1 is a flow chart of an example of an employability skills assessment process;

FIG. 2 is a schematic diagram of an example of a distributed computer architecture;

FIG. 3 is a schematic diagram of an example of a base station processing system;

FIG. 4 is a schematic diagram of an example of a computer system;

FIGS. 5A and 5B are a flow chart of a second example of an employability skills assessment process;

FIG. 5C is a schematic diagram of an example of an indicator is used in a report;

FIG. 5D is a schematic diagram of an example of an indicator of employability skills ratings for each cluster of categories;

FIG. 5E is a schematic diagram of an example of an indicator of employability ratings for each category within a cluster of categories;

FIG. 6 is a flow chart of an example of a process of responding to a survey;

FIG. 7 is a schematic diagram of an example of the overall concept of the employability skills assessment process;

FIG. 8 is a schematic diagram of an example of the user experience of interacting with the employability skills assessment process of FIG. 7;

FIG. 9 is a schematic diagram of an example of the user experience of completing a survey as part of the assessment process of FIG. 7;

FIG. 10 is a schematic diagram of an example of the user experience of interacting with a user dashboard for purpose of management of own survey completion process and for addition of raters as part of the assessment process of FIG. 7;

FIG. 11 is a schematic diagram of an example of the user experience of managing raters as part of the assessment process of FIG. 7;

FIG. 12 is a schematic diagram of an example of the rater experience of completing survey for a user as part of the assessment process of FIG. 7;

FIG. 13 is a schematic diagram of an example of the concept of multi-perspective feedback as part of the assessment process of FIG. 7;

FIG. 14 is a schematic diagram of an example of the method of survey generation and management, including relationships between categories of data used to create the Surveys as part of the assessment process of FIG. 7;

FIG. 15 is a schematic diagram of an example of the relationship between a plurality of versions of survey stored in database;

FIG. 16 is a schematic diagram of an example of the benchmarking and demographic data collection, storage, analysis and reporting; and,

FIG. 17 is a schematic diagram of an example of the features to ensure security of stored information.

### DETAILED DESCRIPTION OF THE PREFERRED EMBODIMENTS

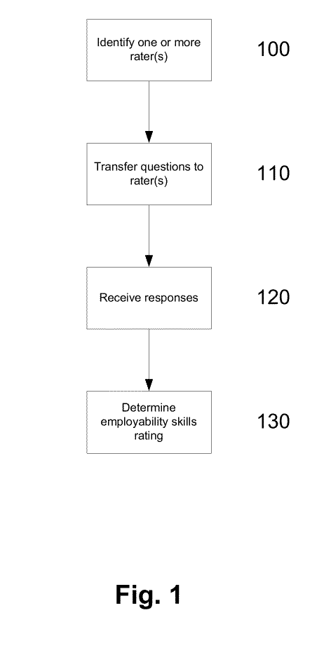

An example of an employability skills assessment process will now be described with reference to FIG. 1.

In this example, it is assumed that the process is performed at least in part using an electronic processing device forming part of a processing system, which is in turn connected to one or more other computer systems via a network architecture, as will be described in more detail below.

For the purpose of the example, the following terminology will be used. The term “assessee” is used to refer to individual that is interacting with the processing system to obtain an employability skills rating. This is typically an individual that is to apply for a role, such as a person seeking employment, applying for an education position or the like. However, this may also include an individual undergoing training, for example as part of a higher education course or “on-the-job” training, and for whom an assessment is required in order to ascertain what, if any, additional training may be required. It will be appreciated however that the assessee need not be immediately applying for employment or training and that the term assessee could therefore apply to any user of the assessment process.

The term “rater” is used to refer to any entity responding to questions regarding the assessee, whilst the term “assessor” is used to refer to any entity that is using the assessment of the assessee using the employability skills rating, and could include a potential employer, an enrolment officer at a higher education establishment, or a trainer, coach or mentor that is to use the assessment to ascertain what if any additional education or training might be required to improve the assessee's employability skills. The term “survey” is used to refer to a collection of questions that are used in assessing the assessee.

The term “employability skills” generally refers to the set of attributes, skills and knowledge that all participants in the labour market should possess to ensure they gain employment in their chosen occupation and have the capability to be effective in the workplace. They benefit individuals, their employer, the workforce, the community and the economy. Employability skills of an individual will generally be based on a number of factors, including but not limited to skills, knowledge, behaviours, attitudes, attributes and the like to ensure ‘best fit’ for an industry, organisation, role, job and culture. Employability can be ascertained at a number of different levels, such as generic, industry specific and job role specific, as will be described in more detail below.

It will therefore be appreciated from the above that the terms “assessee”, “rater”, “assessor”, “survey” and “employability skills” are used for the purpose of clarity of explanation and are not intended to be limiting.

In this example, at step 100 the electronic processing device operates to identify one or more raters in accordance with input commands from an assessee. In particular, the assessee supplies details of one or more raters that are going to provide an assessment of the assessee. This process can be achieved in any suitable manner, but will typically include having the assessee submit predetermined details regarding the rater via an appropriate graphical user interface (GUI) presented by the processing system, for example as part of a webpage or the like. Typically the assessee will provide information regarding the raters, including contact details, such as an email address, telephone number, or the like, together with other optional information, such as a rater type, e.g. family, friend, previous employer, or teacher, as well as an indication of whether the rater would be willing to act as a referee. However, this is not essential and any suitable information could be provided

At step 110, the electronic processing device transfers a number of questions to at least one rater via a communications network. This may be achieved in any suitable manner, such as transferring the questions as part of a message, such as an email message, or the like, although more typically involves hosting the questions on a webpage that can be accessed by the rater, allowing the rater to complete the questions using a suitable computing device, at the rater's convenience.

The questions relate to employability skills of the assessee and can be of any form. For example, the questions can relate to different skills, attributes, or qualifications of the individual that can be used by an assessor in assessing the suitability of the assessee for various roles, such as employment, higher education or the like. The questions will typically be selected from predetermined questions stored in a store, such as a memory or database associated with the processing system, although alternatively assessors can create custom questions, for example to make these specific to a given role or employer, for example to assess a cultural fit between the employee and employer. The questions may be sub-divided into a number of categories and clusters of categories, with questions across the range of categories being provided to the raters, as will be described in more detail below.

At step 120, the electronic processing device receives responses to the number of questions from the rater via a communications network. The manner in which this is achieved will depend on how the questions are provided to the rater and this could involve having the processing system receive a message, such as an email message including the responses. More typically however, the responses are determined based on interaction with a webpage, for example by having the rater select displayed response options using input commands, as will be described in more detail below. The nature of the responses will vary depending upon the preferred implementation, but in one example the questions are in a multiple choice format, with the responses indicating a selection of a particular response choice option. The responses are typically stored in a store, and may be associated with the assessee in some manner, for example by storing these as part of an assessee profile or the like, as will be described in more detail below.

At step 130, the electronic processing device determines an employability skills rating at least partially using the responses. The employability skills rating is at least partially indicative of the assessee's employability skills, and can be used by the assessor in assessing whether the assessee is suitable for given employment, or ascertain training requirements for the individual. The employability skills rating can include a single overall employability rating and/or may include separate employability ratings for different questions, categories or clusters of categories, as will be described in more detail below.

Accordingly, the above-described system provides a distributed arrangement that allows questions to be provided to raters, allowing the raters to provide responses which are in turn used in assessing the employability skills of the assessee, for example to determine if they are suitable for a job or other role, or to do determine what if any additional training may be required.

Thus, the process can be used as part of a recruitment process, for example to allow recruiters or employers to assess potential candidates, as well as allowing individuals to assess themselves, to ascertain whether they will be suitable for a position or role. Additionally and/or alternatively, the process can be used to assess training requirements, for example allowing an assessment to be made of whether an individual requires further training in any given area or employability skills or the like. Thus, this can be used by a student or staff member to perform self-assessment, or by educator, trainers or mentors, to ensure adequate training is provided.

By allowing the transfer of questions to raters via communications networks, this allows a wide range of different raters to be utilised in establishing an employability skills rating associated with the assessee. In particular, it allows individuals dispersed across different geographical locations to be easily contacted and utilised as raters in the employability skills rating process. This in turn maximises the amount of feedback upon which the employability skills rating is based which in turn vastly increases the confidence in the employability skills rating for assessors, such as potential employers or the like.

A further benefit for raters is that this provides a straightforward mechanism for allowing raters to provide an assessment of an assessee. In particular, by providing standardised questions this makes the rating process more straightforward thereby increasing the likelihood that raters will be willing to be involved in assessment of an assessee.

It will further be appreciated that from the assessee's perspective, this provides a centralised mechanism for obtaining an employability skills rating which can then be used in a wide range of different situations, such applying for a new job, seeking a position in higher education, seeking promotion or the like. This in turn makes it viable for the assessee to have an employability skills rating generated irrespective or not of whether a role is being immediately sought. Instead, the automated mechanism for obtaining feedback established by the electronic processing device, allows an assessee to maintain an employability skills rating throughout their careers with this being updated periodically as required, meaning that the employability skills rating is available at any time should the assessee seek to apply for a role, or want to utilise this as guidance as to forms of additional training that might be beneficial. This can also allow development of the assessee's employability skills rating over time to be monitored, allowing assessee to demonstrate areas of improvement.

Furthermore this process can be driven by the assessee, allowing the assessee to select raters that will be able to provide the most comprehensive and appropriate rating for the assessee. So, for example the assessee would not select a school teacher to answer questions about previous employment, but could ask them about the ability to learn and follow instructions.

Finally, from the perspective of assessors, this technique provides a standardised employability skills rating across multiple different assessees. This makes it far easier for employers, or other establishments offering roles, to directly compare different assessees. Furthermore, by requiring that raters are distributed across different rater types, such as family, friends, previous employers, teachers, or the like, this can ensure a greater degree of objectivity to the resulting employability skills rating, therefore making comparison of employability skills ratings between different assessees more meaningful. This in turn provides a rapid and straightforward mechanism for allowing assessors to directly compare the abilities of different assessees.

A number of further features will now be described.

In one example, the electronic processing device selects the number of questions from a plurality of predefined questions stored in a store. Thus, the processing system will typically maintain a large database of questions, with only selected ones of these questions being provided to raters.

The questions can be selected based on categories associated with, for example, different industries, roles, skills, attributes, or the like, thereby allowing surveys to be tailored for specific scenarios. For example, surveys could be generic and apply to multiple industries, or alternatively could be industry or even job specific, in which case different questions would be used.

Whilst the assessor or assessee may select particular questions, more typically the questions are selected randomly from a pool of questions based on a selection of one or more categories. Using categories in this manner, allows relevant questions to be identified by selecting a category and/or cluster of categories, without assessors or assessees having to go the extent of selecting individual questions themselves.

Allowing a subset of a greater number of questions to be used, can allow different questions to be provided to different raters, thereby maximising the range of feedback provided regarding a particular assessee. This can also reduce opportunity for fraudulent assessments occurring by preventing assessees providing standard answers to raters across the questions that are provided, given that each rater will typically receive different questions. However, it will be appreciated that this is not essential and the same questions may be provided to multiple different raters.

Questions may also be defined by assessors, so for example, in the event that a potential employer wishes to create a survey for a specific job, the assessor can define questions, which would then typically be stored in the store, allowing these to be selected for inclusion on a custom survey.

In one particular example, the electronic processing device determines selection of at least one question category in accordance with input commands from an assessee and then selects the number of questions in accordance with the at least one question category. This can be achieved in any appropriate manner, but typically involves having the electronic processing device cause details of available surveys to be displayed to the assessee, for example via a webpage, with the assessee selecting an available survey using appropriate input commands. The appropriate survey may be industry or role-specific and will typically include selection of one or more predefined categories. However, this is not essential and alternatively the question categories can be selected manually.

The questions and hence categories typically relate to one or more of skills of the assessee, attributes of the assessee, industries, a role for the assessee, education of the assessee, employability skills and industry-specific skills. Thus, it will be appreciated that assessees may select different categories depending on the nature of the role or industry for which an application is being made. Thus, for example, an assessee seeking employment in the mining industry may select different categories to an assessee seeking employment in the hospitality industry.

By providing a wide range of categories, this allows for a high degree of flexibility in respect of the questions used, allowing assessees or assessors to tailor surveys to meet specific requirements. For example, the questions could be tailored to be industry specific, such as relating to the medical industry, or alternatively could be directed to specific roles, such as a brain surgeon, whilst also covering generic skills such as literacy and numeracy, as required. Surveys may include a combination of generic, industry specific and job role specific questions, depending on particular requirements.

Typically, the categories are grouped into clusters of related categories. The clusters are used at a high level to allow different attributes/skills to be grouped together, so that an overall employability skills rating can be determined for each category, thereby providing an assessor with a high level overview of the employability skills of the assessee, as will be described in more detail below. In general, the survey will include multiple categories across each cluster, thereby ensuring a range of different feedback about the assessee.

In one example, the clusters of categories include clusters relating to the employability skills of the assessee, including but not limited to: personal attributes; working with others; achieving at work; future skills; and learning.

In this example, the personal attributes cluster includes categories relating to: honesty/integrity; social responsibility; motivation/enthusiasm; positive attitude; resilience; self-awareness/self-management; reliability/responsibility; autonomy/independence; and, personal presentation.

The Working with Others cluster includes categories relating to communicating with others; leading and influence; respect for diversity; team/group outcomes; engaging networks; connectivity/social intelligence; and conflict resolution.

The Achieving at Work cluster includes categories relating to professionalism/work ethic; customer service; written communication; numeracy; using tools and technology; critical thinking/problem solving; understanding context of work; working safely; finding and managing information; planning, organising and implementing; and, delivering results.

The Future Skills cluster includes categories relating to technical competency; media communication; information analysis capabilities; navigating trends and choices; design mindset; connection and collaboration; being a global citizen; personal mastery; and career architect.

The Learning Skills cluster includes categories relating to learning at work; adaptability; flexibility; and lifelong learning.

In one example, the clusters of categories include clusters relating resilience of the assessee. In this regard, resilience is the ability to persevere, adapt and excel through life's challenges including adversity, change, ambiguity and crises. The science of resiliency psychology has identified the skills and abilities that contribute to an individuals' ability to overcome adversity and bounce back from setbacks. Examples of the clusters of categories for assessing resilience include but are not limited to: connect with self; navigate events; connect with others and build resilient cultures.

Examples of specific categories include, for the connect with self cluster: positive mind set; self efficacy; self aware; emotion regulation; impulse control; accurate explanatory style (casual analysis); self esteem; self confidence; and health and wellbeing. Categories for navigate events can include: manage change; positive action; conflict resolution; accepts complexity of life; problem solving; and, adaptability. Categories for the connect with others cluster can include: proactive relationships; connective communication; empathy; social supports; humour; and, reaches out. Categories for the build resilient cultures category can include: promote resilience; model resilience; and lead development of resilience.

In another example, the clusters of categories include clusters or categories relating to cultural values of an employer. Such questions are typically specific to given employers and are therefore more often defined on a case by case basis by the employer. This can be performed to ensure that the assessee will fit within the culture of the employing firm or the like.

It will also be appreciated that whilst the above-described example uses selection of categories by the assessee, alternatively an assessor may define a particular survey for a given role and then arrange for this to be hosted by the electronic processing device such that any assessee applying for the role will need to have the associated survey completed by raters on their behalf. This allows assessors to ensure standardised information is collected regarding each assessee being assessed.

In the above-described example, the questions are answered by raters who are different to the assessee. However, typically the process also includes having the assessee themselves answer questions in a self-assessment procedure. This is typically achieved by transferring a number of questions to the assessee via a communications network, receiving responses to the number of questions from the assessee via the communications network and then determining an employability skills rating at least partially using the assessee responses. It will be appreciated that this provides a mechanism for including both external and self-assessment of an assessee and furthermore allows comparison between the external and self-assessment, which can provide useful information to the employer, for example, in the event that the assessee perceives their abilities to be significantly different to those assessed by external parties.

Typically the electronic processing device generates an indication of the employability skills rating and more typically provides an indication of the employability skills rating via the communications network as part of a publication process. This can involve providing an indication of the employability skills rating to the assessee, any raters, or an assessor, for example as part of a message sent to the relevant party. However, alternatively, this could involve publication by posting of the employability skills rating on a website or the like. For example, the employability skills rating could be provided to a server of a social media network or other social media platform for online publication. Thus, in one example, the employability skills rating can be automatically provided to an assessor as part of an application process, but can also be published as part of an assessee's social media profile. For example, the assessee may have a Linked-In™ profile and the employability skills rating can be added to the profile allowing third parties to easily ascertain information regarding the assessee's abilities.

The employability skills rating can take any form such as a numerical value, or alternatively a scale rating value, such as “frequently”, “usually”, or “infrequently”, or “very good”, “good”, “average”, “bad”, “very bad”, depending on the nature of the question. In this regard, the electronic processing device typically determines the rating for the assessee using the responses and then generates an indication of the employability skills rating at least partially in accordance with these responses. Whilst a single employability skills rating can be provided, more typically a separate employability rating might be generated for each question, each category of questions, or each cluster of categories, depending for example on results from a number of raters.

For example, in the event that the questions have predetermined response options, such as multiple choice questions, the processing system compares the response option provided by each rater, and then generates the employability skills rating based on these responses, for example based on an average, variation or the like.

In one example, different response options can be associated with respective numerical value, allowing a numerical employability rating to be determined. In this instance, the electronic processing device determines the employability skills rating at least in part based on the selected response options and the associated rating value. Thus, the responses provided by each of the raters can be used to sum the rating values associated with the different responses for each question and generate an overall score. Such scores can be determined on a per-category or per-cluster basis so that the assessee has an established score for each category and/or each cluster of categories. However, this is not essential and any rating system can be used.

In one example, the employability skills rating which is made available can include a employability skills rating based on an average response for each rater, a highest response for each rater, a lowest response for each rater and a response of each rater in a group of raters allowing various different types of information to be made available to assessors. It will be appreciated however that any suitable arrangement can be used.

As previously mentioned, raters may be grouped according to a rater type and the method can include determining a respective employability skills rating for each group of raters. This can be used to allow assessors to distinguish between raters that are family, raters that are friends, previous employers, educators, or the like, thereby allowing the assessor to gain an understanding of the perception of the assessee across a range of different backgrounds. Alternatively, raters could be grouped randomly.

Typically, the electronic processing device generates a report including one or more of an indication of one or more employability skills rating(s), one or more responses of at least one of the assessee and at least one rater, a comparison of responses of the assessee and at least one rater, a comparison of a first employability skills rating based on assessee responses and a second employability skills rating based on later responses. Thus, it will be appreciated that by collating responses from a number of different raters and the assessee this allows a wide range of information to be provided to the assessor making it easier to comparatively assess different assessees.

Additionally, the report can include any other relevant information. This could include, for example, an indication of an identity at least one rater, allowing the rater to be contacted by the assessor so that the rater can act as a referee for the assessee, as well as any additional comments made by raters, or the like.

In a further example, the processing system 210 can be adapted to record information regarding completion of the survey by raters, and provide information regarding this, such as a date of completion. This allows assessors to understand a context, such as when the assessee was last assessed, allowing them to determine how much weight should be applied to the employability rating.

The indication of the employability skills rating can include a graphical and/or alpha numerical representation of the employability skills rating although any suitable presentation mechanism can be used. This may also include a breakdown including an employability skills rating for each category or cluster of categories, as will be described in more detail below.

The electronic processing device is also typically configured to administer the survey process and in particular ensure that responses are provided by a number of suitable raters. In one example, this is achieved by having the electronic processing device generate a reminder in the event that responses to questions have not been received after a predetermined time interval. In this example, a number of different reminders can be sent and in the event that responses have not been received from a rater after a predetermined number of reminders have been sent, the assessee can be required to identify an alternative rater allowing an alternative rater to be used.

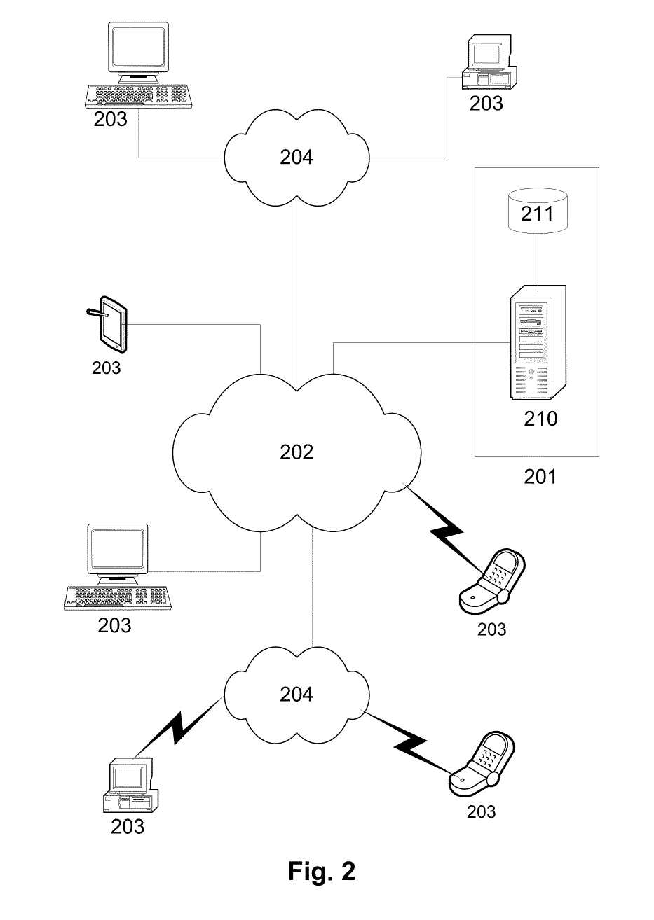

In one example, the employability skills assessment process is performed by one or more processing systems operating as part of a distributed architecture, an example of which will now be described with reference to FIG. 2.

In this example, a base station 201 is coupled via a communications network, such as the Internet 202, and/or a number of local area networks (LANs) 204, to a number of computer systems 203. It will be appreciated that the configuration of the networks 202, 204 are for the purpose of example only, and in practice the base station 201 and computer systems 203 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In one example, the base station 201 includes a processing system 210 coupled to a database 211. The base station 201 is adapted to be used in running the employability skills assessment process and in particular, in coordinating the survey process, maintaining employability skills ratings as well as information regarding assessees and raters, and to administer billing and other related operations. The computer systems 203 are therefore adapted to communicate with the base station 201, allowing question responses and other information to be submitted, as well as allowing details of surveys and employability skills ratings to be reviewed.

Whilst the base station 201 is a shown as a single entity, it will be appreciated that the base station 201 can be distributed over a number of geographically separate locations, for example by using processing systems 210 and/or databases 211 that are provided as part of a cloud based environment. However, the above described arrangement is not essential and other suitable configurations could be used.

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example the external interface 303 can be utilised for connecting the processing system 210 to peripheral devices, such as the communications networks 202, 204, databases 211, other storage devices, or the like. Although a single external interface 303 is shown, this is for the purpose of example only, and in practice multiple interfaces using various methods (eg. Ethernet, serial, USB, wireless or the like) may be provided.

In use, the microprocessor 300 executes instructions in the form of applications software stored in the memory 301 to allow the employability skills assessment process to be performed, as well as to perform any other required processes, such as communicating with the computer systems 203. The applications software may include one or more software modules, and may be executed in a suitable execution environment, such as an operating system environment, or the like.

Accordingly, it will be appreciated that the processing system 210 may be formed from any suitable processing system, such as a suitably programmed computer system, PC, web server, network server, or the like. In one particular example, the processing system 300 is a standard processing system such as a 32-bit or 64-bit Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

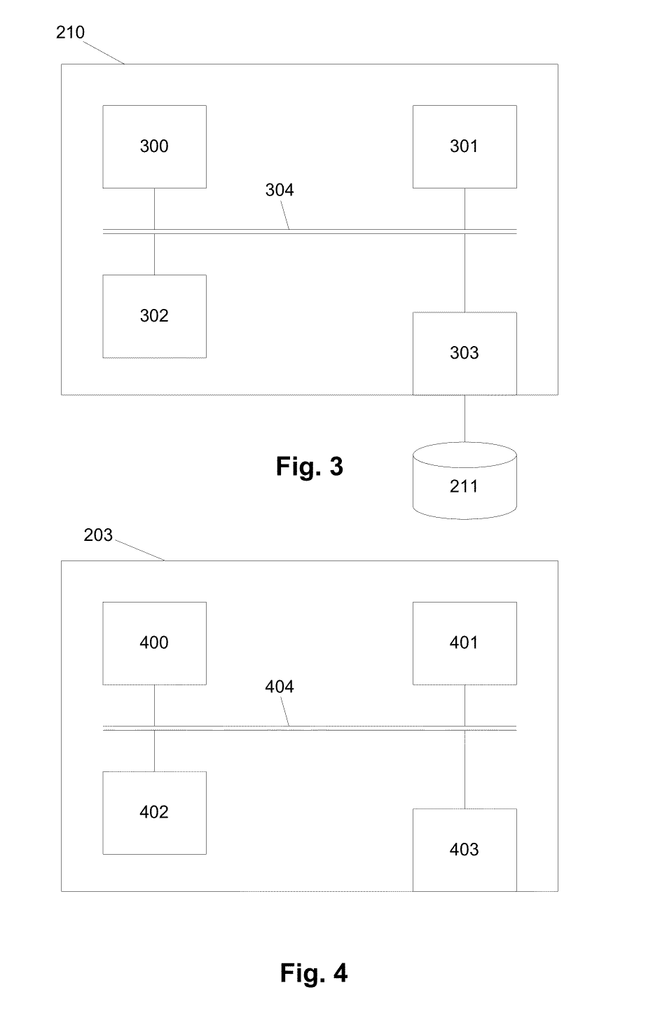

As shown in FIG. 4, in one example, the computer system 203 includes at least one microprocessor 400, a memory 401, an input/output device 402, such as a keyboard and/or display, and an external interface 403, interconnected via a bus 404 as shown. In this example the external interface 403 can be utilised for connecting the computer system 203 to peripheral devices, such as the communications networks 202, 204, databases 211, other storage devices, or the like. Although a single external interface 403 is shown, this is for the purpose of example only, and in practice multiple interfaces using various methods (eg. Ethernet, serial, USB, wireless or the like) may be provided.

In use, the microprocessor 400 executes instructions in the form of applications software stored in the memory 401 to allow communication with the base station 201, for example to allow data to be supplied thereto.

Accordingly, it will be appreciated that the computer systems 203 may be formed from any suitable processing system, such as a suitably programmed PC, Internet terminal, lap-top, hand-held PC, smart phone, PDA, web server, or the like. Thus, in one example, the processing system 300 is a standard processing system such as a 32-bit or 64-bit Intel Architecture based processing system, which executes software applications stored on non-volatile (e.g., hard disk) storage, although this is not essential. However, it will also be understood that the computer systems 203 can be any electronic processing device such as a microprocessor, microchip processor, logic gate configuration, firmware optionally associated with implementing logic such as an FPGA (Field Programmable Gate Array), or any other electronic device, system or arrangement.

Examples of the employability skills assessment process will now be described in further detail. For the purpose of these examples, it is assumed that the processing system 210 maintains a user account for each assessee, set-up during a registration process. The user account can store information relating to the assessee, such as authentication information, employability skills ratings, contact information or the like. As part of the registration process, a potential assessee may also undergo identity verification, for example by having them supply identification information, such as passport, credit card details and the like. This can be used to avoid fraudulent use of the system, as well as to meet financial auditing requirements.

It is also assumed that the processing system 210 hosts webpages allowing assessees to browse and create surveys, allowing assessees and raters to view and complete surveys, and allowing employability skills ratings to be displayed. The processing system 210 is therefore typically a server which communicates with the computer system 203 via a communications network, or the like, depending on the particular network infrastructure available.

To achieve this the processing system 210 of the base station 201 typically executes applications software for hosting webpages and performing the employability skills assessment process, with actions performed by the processing system 210 being performed by the processor 300 in accordance with instructions stored as applications software in the memory 301 and/or input commands received from a user, such as an assessee or rater via the I/O device 302, or commands received from the computer system 203.

It will also be assumed that the user interacts with the processing system 210 via a GUI (Graphical User Interface), or the like presented on the computer system 203, and in one particular example via a browser application that displays webpages hosted by the base station 201. Actions performed by the computer system 203 are performed by the processor 400 in accordance with instructions stored as applications software in the memory 402 and/or input commands received from a user via the I/O device 403.

However, it will be appreciated that the above described configuration assumed for the purpose of the following examples is not essential, and numerous other configurations may be used. It will also be appreciated that the partitioning of functionality between the computer systems 203, and the base station 201 may vary, depending on the particular implementation.

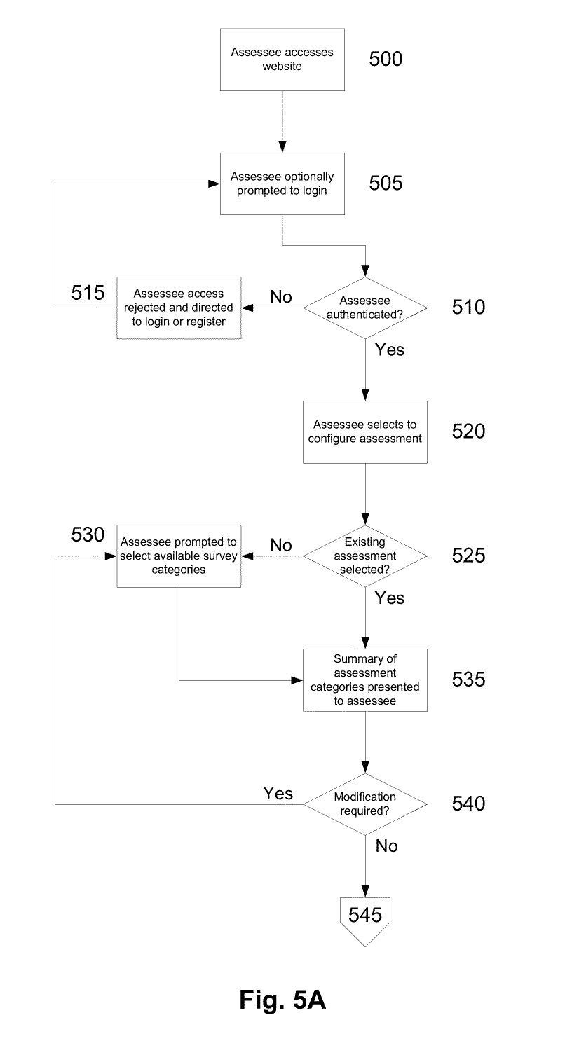

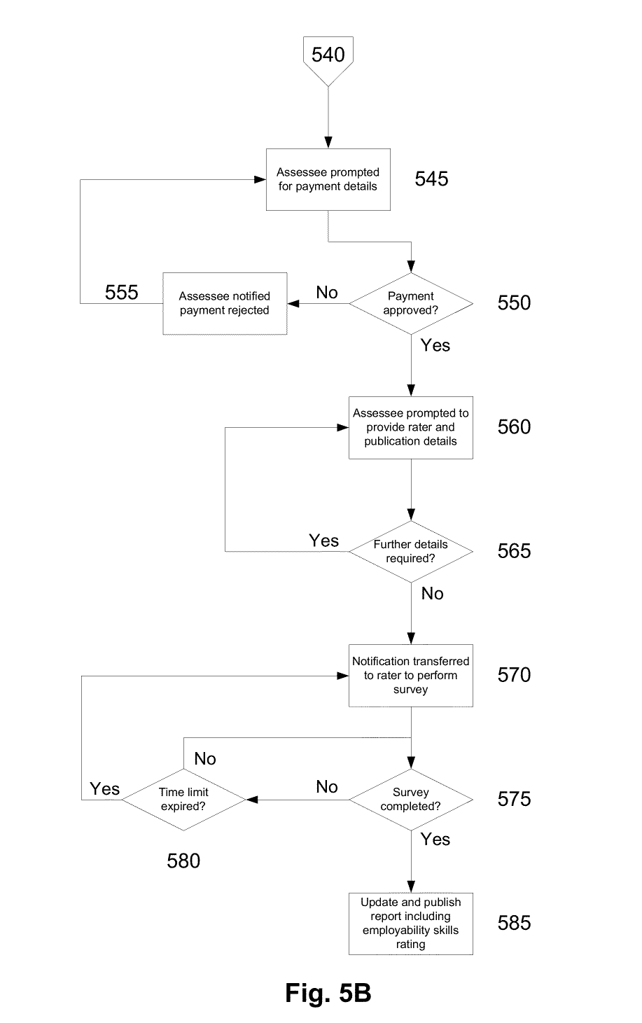

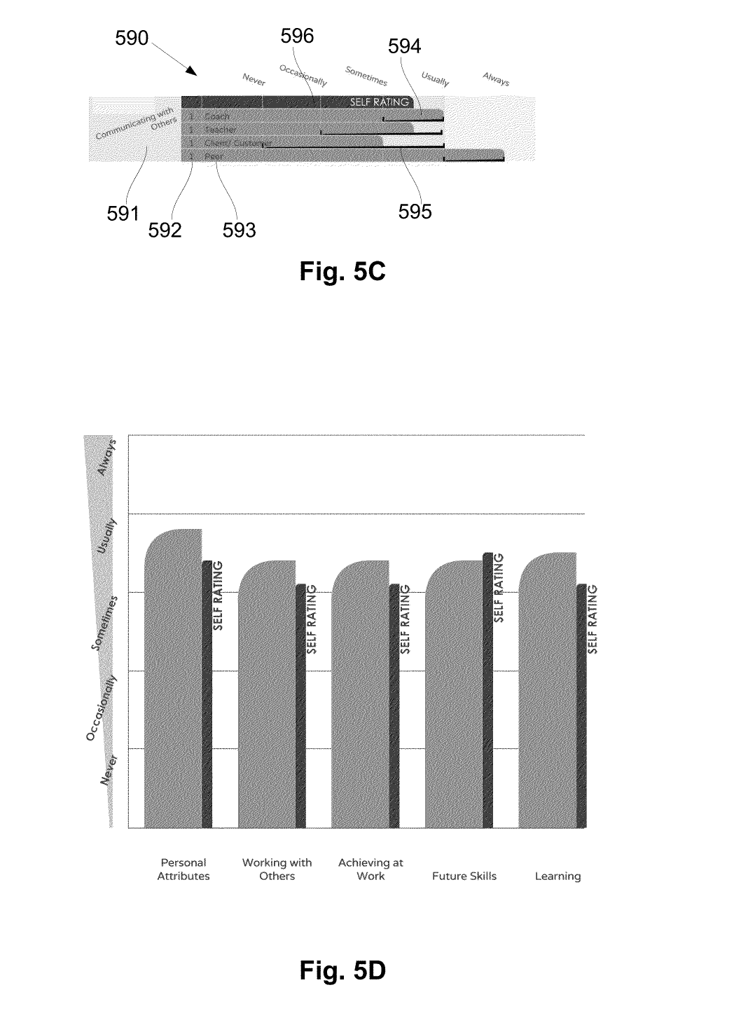

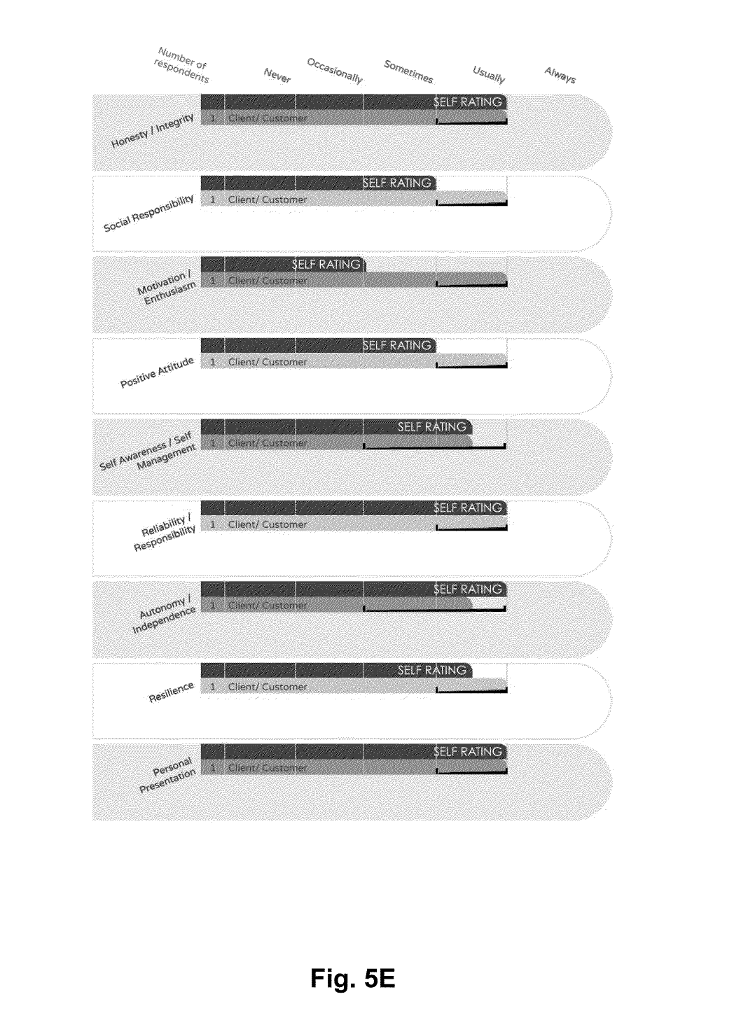

A second example process for rating an assessee using the apparatus for FIGS. 2 to 4 will now be described with reference to FIGS. 5A and 5B, and with reference to the example report indications in FIGS. 5C to 5E.

In this example, at step 500 the assessee accesses a website hosted by the processing system 210. At step 505 the assessee is optionally prompted to login, with this process being utilised to identify the assessee, allowing this to be used to maintain a profile relating to the assessee, including, for example, historical employability skills ratings, personal information of the assessee and any associated raters, or the like. Such a profile is typically established during registration process as will be appreciated by a person skilled in the art and this will not therefore be described in further detail. It will be appreciated that login may be achieved utilising any suitable technique but typically involves having the assessee submit authentication information such as a user name, password, biometric information, or the like. Such login procedures are well known in the art and will not therefore be described in any further detail.

In the event that the assessee login fails for any reason, such as if the assessee is not authenticated at step 510, the process moves to step 515 with the processing system 10 indicating that assessee access is rejected and directing assessee to login or register.

Once the assessee has been authenticated and logged-in, at step 520 the assessee selects to configure an assessment, typically by selecting an appropriate option presented to the assessee via a webpage hosted by the processing system 210. As part of this process, the processing system 210 will typically display a list of available assessments or surveys as they are more commonly referred to. In particular, the processing system 210 will display a list of available surveys allowing any one of these to be selected by the assessee. Additionally and/or alternatively, an assessee may elect to define their own survey.

At step 525, the processing system 210 determines if an existing assessment has been selected and if so operates to display a summary of the assessment to the assessee, typically including details of categories covered by the assessment, and the clusters in which the categories are grouped. As mentioned above, the categories can relate to different industries, roles, skills, attributes, or the like, allowing the assessee to ensure that the categories would cover all areas of interest to a potential assessor. In general, this will also ensure that categories within each cluster defined above are selected. In one example, the survey may be defined by an assessor, so that an assessee that is applying for a particular role can simply select the relevant survey.

Otherwise, at step 530, the processing system 210 displays a list of available categories to the assessee allowing the assessee to select one or more of the categories for inclusion on the survey. The selected categories are then presented to the assessee at step 535.

Once the summary of categories has been displayed, the assessee can choose whether to accept or modify these through the selection of an appropriate input option displayed on the webpage. For example, if the assessee has not selected any categories within one of the clusters, an indication might be displayed prompting the assessee to select additional categories. At step 540, the processing system 210 determines if modification of the categories is required in which case the process returns to step 530.

Once the categories are indicated as acceptable, the process moves on to step 545 with the assessee being prompted for payment details. In particular, the assessee is required to select the assessment survey first as the revenue model may depend on charging different amounts of money for different surveys, for example, depending on the number of categories selected. Furthermore, payment is typically required up-front of actual completion of the survey and publication of the employability skills rating in order to ensure that the operator is reimbursed for performing the survey, although it will be appreciated that this is not essential and other arrangements could be used.

At step 550, the processing system 210 determines if payment has been approved and if not notifies the assessee that payment has been rejected at step 555 returning to step 545 to allow the assessee to provide alternative payment details.

Once payment has been processed successfully, at step 560 the processing system 210 displays a webpage including respective fields for prompting the assessee to provide rater and publication details. In particular, the assessee will be required to identify one or more raters, and provide associated contact details, allowing the survey to be provided to the raters for completion. In one example, different rater types are defined, such as friends, family, co-workers, teachers, or the like, with the assessee needing to identify groups of raters, each group including one or more raters of a particular rater type. This can be used to ensure a balanced assessment is provided of different attributes and skills of the assessee. The assessee will also be required to enter publication details including, for example, whether the employability skills rating is to be forwarded to a potential assessor, or whether it is to be published as part of a social media profile, or the like.

It will be appreciated that at step 565, the processing system 210 can determine if sufficient information has been provided, for example if all displayed fields are completed, and if not the process returns to step 560 with the assessee being prompted to provide further information as required.

At step 570, a notification is transferred to a rater, asking them to perform the survey. The notification may be generated in any suitable manner, but in one example, is in the form of an email, SMS or other similar notification which is transferred to the rater via a communications network. The notification may also include other information relevant to the rater, including for example, an indication that contact details of the rater may be included in reports so that the rater can act as a referee, in which case the rater may also be required to provide permission for this to occur, and also confirm contact details are correct.

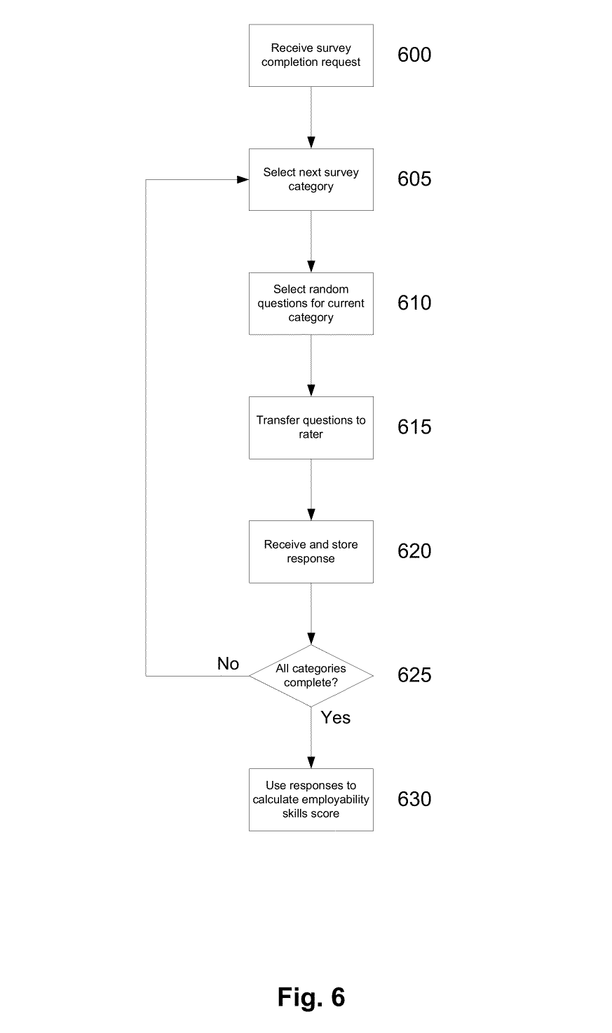

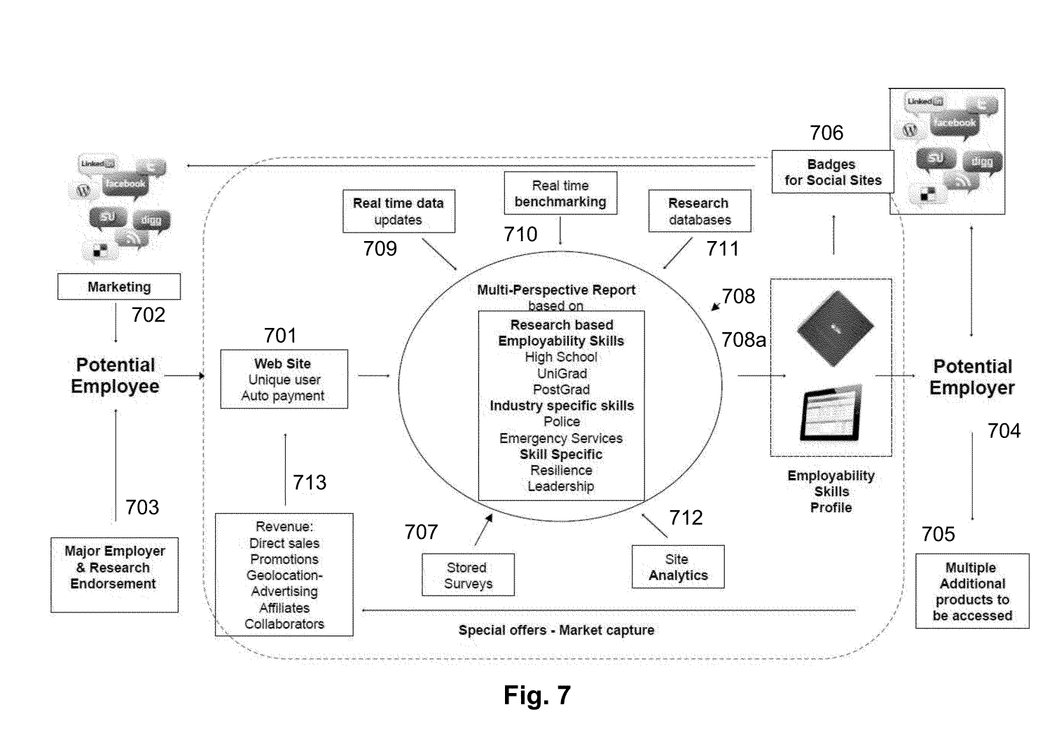

The notification typically also includes a link such as a Universal Resource Locator (URL) which the rater can select thereby directing them to a website hosted by the processing system 210, which includes the survey for completion. The manner in which completion of the survey is performed will be described in more detail below with reference to FIG. 6.

As part of this process, the assessee may be treated as a rater and required to complete a survey of themselves. In one particular example, the process of forwarding the survey to the raters will not be completed until an assessee has completed the survey themselves. Irrespective of this, as the process is essentially the same for assessees and raters, the following description will focus on completion of the survey by the raters for the purpose of ease of explanation.

At step 575, the processing system 210 determines if the survey is completed and if not, determines whether a time limit has expired. If a time limit has not expired the processing system 210 continues to wait until such time as either the survey is completed or the time limit expires. In the event that the time limit expires, the processing system 210 transfers a reminder notification to the rater requesting that they complete the survey. This process can continue until the rater completes the survey, or alternatively the processing system 210 can monitor the number of notifications generated and if the number exceeds a predetermined number, the processing system 210 ascertains that the rater will not complete the survey and arranges for the survey to be sent to an alternative rater. This may involve, for example, having the processing system 210 contact the assessee, for example, by displaying a notification to the assessee either via email, SMS, or the like, or via a dashboard which will be described below. This allows the assessee to select an alternative rater and arrange for this process to be repeated. It will be appreciated that the processing system 210 therefore automatically reminds raters to complete the survey, and in the event that this does not occur, seeks an alternative rater, thereby ensuring an employability skills rating is generated.

The time limit and number of reminders that issue can be standardised, or alternatively could be defined by the assessee, thereby ensuring that an employability skills rating is provided within a required time frame, for example in the event that the assessee is applying for a position with a defined cut-off date.

At step 585, as survey responses are received, the processing system 210 operates to update employability skills ratings and then publish a report including the employability skills rating. The nature of the report will vary depending on the preferred implementation. In one example however, the report includes information such as a numerical employability skills rating value, a breakdown of rating values for different clusters and/or categories of skills or attributes, as well as for different groups of raters. Such values can be based on averages across the categories or raters, and may include additional statistical information such as standard deviations or the like.

An example of an indicator used in the report is shown in FIG. 5C. In particular, in this example, the indicator 590 is used to display employability skills ratings associated with a respective category. In this instance, the indicator 590 relates to a respective category and includes a category indication 591 identifying the category. The indication includes responses from a number of groups of raters, with a rater number 592 and group identifier 593 identifying a number of raters in the respective group. Each group includes a first bar 594 indicating the average response of the respective group and a second bar 595 highlighting the highest and lowest response, thereby showing the variance within the group. Additionally, the assessee's employability skills rating is shown at 596 for comparison.

Each report typically includes an overview of the employability skills rating for each cluster, as shown in FIG. 5D, as well as separate indicators shown the breakdown for each of the categories within the cluster, as shown in FIG. 5E.

The report can also include example responses, comments made by raters, as well as graphical representation of one or more employability skills ratings, and comparisons between ratings based on rater responses and assessee responses. The report may also include details of raters willing to act as referees for the assessee, as well as any other pertinent information.

The report may also include additional information, such as guidance to the assessee or assessor, such as to outline key development needs for the assessee. In one example, this can be accompanied by information regarding available training, based for example on information regarding available service providers. This could use geolocation information to ensure that the assessee is provided with information regarding locally available service providers and/or globally available online providers. This can be automated so that this is included on all reports to the assessee, or alternatively may be performed manually by allowing assessee to search a directory of service providers maintained by the base station 201.

Publication of the report may take any one of a number of forms, such as forwarding the completed report to the assessee and/or to a rater at a designated contact address. Alternatively, the report may be forwarded to a potential assessor allowing them to assess the assessee. A further alternative is for a report, link to the report, or summary of the report, such as an employability skills rating value or badge indicating that a report is available, to be displayed via a social media platform. In this instance, the processing system 210 operates to forward the employability skills rating or other relevant information to a server of the social media platform, together with information regarding an account of the assessee, thereby allowing the employability skills rating to be published as part of the assessee's social media profile. Additionally, this can be used to allow comments to be added to reports. For example, if a third party endorses or recommends the assessee via social media, for example via Linked-In™, and selects an appropriate option, these can then be added to the assessee's report.

During the above assessment process, additional information can be collected and stored by the processing system 210, including for example, date and time information relating to when raters completed a survey, with this optionally being included on the reports, allowing for example, assessors to understand how current the assessment is.

The processing system 210 may also be adapted to perform additional checks during the survey process. For example, the processing system 210 may determine identification information regarding devices used by the assessee and raters, such as an IP address or hardware specific MAC address, or the like. These can then be compared using rules to flag situations where there is a potential for attempted fraudulent behaviour. For example, in the event that the assessee and a number of raters all use the same IP address, this suggests that the assessee is acting to rate themselves, and accordingly the processing system 210 could be adapted to generate an alert or notification, so that the legitimacy of the raters is checked before the report is published.

Accordingly, the above described process allows the employability skills rating to be generated and published substantially automatically, thereby simplifying the process for the assessee and raters. This also allows reports to be updated progressively as responses are received from raters, so that the assessee can obtain an employability skills rating as soon as possible. It will be appreciated however, that the report can be provided to the assessee prior to being published, thereby allowing the assessee to approve publication, enabling the assessee to prevent any unwanted results being published.

An example of the manner in which a survey is performed will now be described with reference to FIG. 6.

In this example, at step 600 the processing system 210 receives a survey completion request. This may be achieved in any appropriate manner but typically involves having a rater or assessee select a link corresponding to a survey complete request, provided in the notification sent by the processing system 210 at step 570 above.

At step 605, the processing system 210 selects a next survey category within the survey and then selects random questions for the current category at step 610. In this regard, the processing system 210 will maintain a repository including questions associated with different survey categories. The processing system 210 will then select random questions from within the current category and then transfer these questions to the rater at step 615, for example, by displaying these to the rater via a webpage. By selecting questions randomly from a pool of questions associated with each category, this can ensure that the different questions are presented to different raters, reducing the likelihood of raters being instructed to provide standard answers, in turn reducing the opportunity for fraudulent use of the system.

At step 620, the processing system receives and stores any responses. Thus, it will be appreciated that in one example, the rater is presented with a webpage outlining the questions and possible responses in the form of multiple choice questions. The assessee can select responses and then click a ‘Submit’ button with the responses being received by the processing system 210 at step 620.

At step 625, the processing system 210 determines if all categories have been completed and if not moves on to select the next category at step 605. Otherwise, if it is determined that all categories have been completed the processing system 210 calculates an assessee's score at step 630. This can be achieved in any suitable manner, but typically involves having a defined rating value associated with each possible question answer, allowing the processing system 210 to simply sum rating values for the different responses provided. It will be appreciated that the processing system 210 can ascertain rating values for each category, and use this to generate statistical information for inclusion in the report, as set out above.

In the above described example, the survey is defined by the assessee. However, this is not essential, and the survey can instead be defined by any individual or entity. For example, in the event that the system is being used for recruitment, the assessor could be an employer that creates a specific job role related survey, which any job applicants must then complete. In this regard, the job applicants could then access the website hosted by the processing system 210 and arrange for the survey to be completed, in a manner similar to that described above, with results being forward to the employer. This ensures that the employer obtains an employability skills assessment for each applicant for the role, which is specific to the role in the question, and therefore provides more valuable feedback than generic surveys. This also allows the employer to more easily perform a direct comparison of the skills and other attributes of potential employees, making it easier for the employer to assess which applicant would be best for the job.

In one example, the processing system 210 can be adapted to perform comparisons on behalf of an assessor.

The comparison could be to compare the employability skills of different assessees to each other. So, for example, an assessor can select a number of assessees, with the processing system 210 comparing the employability ratings for the assessees, for example on an overall, cluster and/or category basis, allowing the processing system 210 to provide an indication of the relative suitability of candidates, for example by ranking the candidates in order based on their employability ratings.

Additionally, and/or alternatively, the comparison could be to predefined criteria, such as minimum requirements for a role. In this instance, an assessor could define employability criteria, by specifying minimum employability skills ratings on an overall, category and/or cluster basis. The processing system 210 can then perform a comparison of the employability skills ratings of one or more assessees, against the criteria, allowing the processing system 210 to automatically determine whether assessees meet the requirements.

In one example, the comparison could be performed for specific assessees, such as applicants for a job. Alternatively this can be performed across any assessee using the system, or any that have indicated they are available for employment in profile settings, allowing the processing system 210 to automatically produce a short list of potential candidates that may be suitable and/or available for a specific role.

Thus, this effectively provides a mechanism for potential employers to perform a search of assessees within the system to identify those that would be most suitable for a particular role or position. This can be performed solely on the basis of employability skills, but could also take into account other information, such as the assessee's location, number of years of experience, qualifications etc. The employer can then obtain a summary or report relating to assessees that meet the requirements, so this allows potential employers to perform a search of assessees and more easily identify those that will meet their organisational needs.

Accordingly, the above described process provides a method of generating and presenting multi-perspective feedback on generic and industry specific employability skills for use by a potential job applicant, employer, educator or the like, allowing for data collection and management for global research and benchmarking of employability skills.

In one example, the above described process can provide an automated online method and apparatus designed specifically for multi-perspective (self and external to self, multi-rater) testing of potential job assessees or students against a set of job ready criteria (based on research of internationally recognised employability skills, for both general and industry specific applications), generating a multi-media personal report for posting on social and job platforms and for distribution to prospective employers, and capturing, analysing and reporting global benchmarking data for the analysis of cultural and other demographic differences in employability skills.

The processes have been developed primarily for the purpose of testing the employability skills of a potential job assessee against a set of industry defined employability skills, and assessing, developing and reporting on employability skills or the like in students (high school, vocational, university and other). However, the processes are not limited to this application and can be expanded into the broader field of recruitment, education, skill development and research.

The employability skills assessment process further allows the collection of global demographic data on employability skills. This then allows the further analysis of said data, to generate further understanding of the impact of multi-variate demographic filters on employability skills.

This employability skills assessment process is applicable to a wide range of users, including but not limited to:

individuals (assessees, who want to create a personal profile for the purpose of a job application, or professional development)

private organisations (who want to use this as a recruitment screening or staff development tool)

public sector institutions (who want to use this as a recruitment screening or staff development tool)

educators (to provide a robust method for employability skills assessment for the purpose of assessing a students current employability skills, designing an employability skills development program for students individually and collectively, and for reporting the attainment of employability skills on graduation in addition to current academic achievements)

researchers (for the purpose of analysing previously unavailable information and data sets on global employability skills)

The employability skills assessment process can provide an automated online platform (method and apparatus) designed specifically for multi-perspective (external to self, multi-rater) testing of potential job assessees against a set of job ready criteria (based on research of internationally recognised employability skills, for both general and industry specific applications), generating a multi-media personal report for posting on internet and other media-based social and job websites and for distribution to prospective employers, and capturing, analysing and reporting global benchmarking data for the analysis of cultural and other demographic differences in employability skills.

Further, the employability skills assessment process is for use by educators in the assessment, development, and reporting of employability skills for students.

Further details for a specific example will now be described and for this purpose the term user will typically refer to an assessee.

Features of the platform can include:

A novel method of measurement for ‘employability skills and attitudes’ and ‘industry specific skills and attitudes’.

An assessment methodology that draws together the perspectives of multiple external Raters and generates a unique profile for the User.

A report generator that produces both pdf files and an interactive multi-media output for interaction by the end user and potential employer or researcher.

Real-time updating of User demographic information and personal results for comparison against normative data (also generated by the system).

Collection mechanisms for global demographics and survey User results for the purpose of building a normative sample population, and allowing further focused research into multi-variate demographic influence on employability skills.

Flexible report generators to facilitate the construction of research activities.

Integrated marketing and promotional system for connection to social-media platforms and auto-payment.

Geo-location targeted development advertising based on outcomes of the report.

Flexible capacity to add more features and profiles based on inherent learning from Site Analytics.

Automated, self-contained, stand-alone functionality (requires no external facilitation or administration, other than for management, updating and fault rectification) with all actions prompted by a registered user.

Global deployment and application, multi-lingual and culturally sensitive.

It will be appreciated that the above described platform brings together a number of existing technologies into a novel method and application that has not previously been invented. Bringing together of these ideas in this novel way, and the combining of the new data also in novel ways, further allows the creation of new information and knowledge that has not previously existed, for the purpose of global research into factors influencing employability skills based on demographic segmentation (eg culture, industry, age, occupation, etc).

In this regard, employers, globally, have identified a set of job ready′ or ‘employability’ skills and attributes that they desire employees to possess in addition to their technical/specialist skills and qualifications.

However, whilst there has been significant global research into identifying these employability skills and attributes, as they are perceived as a valuable predictor of job performance, other than self-reporting, there is currently no method available for measuring these employability skills and attributes in a meaningful way and there is no method available for reporting to potential employers whether a potential employee possesses these skills and attributes or not, and to what degree (in comparison to another person). There is also no currently defined ‘standard’ that allows comparison of one person's skills and attributes against another.

Accordingly, the employability skills assessment process provides a computer implemented systems, methods, apparatus and graphical user interfaces comprising, or in communication with, a database of information supplied both by the User (job applicant) and raters, drawn together in such a way as to produce a multi-tiered report for use as part of a job application or skill development process.

In one example, the employability skills assessment process resides in a computer-implemented method of assessment and reporting of employability and industry specific skills, the method including:

A User completing an assessment survey of employability skills against a stored database of employability skills.

A series of Raters completing an assessment survey on a given User, against a stored database of employability skills.

Storing of User data and Rater results in a method that allows later retrieval and manipulation into a report format.

Populating a report, comprising individual self-assessment against predetermined list of behavioural descriptors for the given market segment; the average of Raters assessment of User, presented by cohort (for example but not limited to employer, coach, teacher, family member, etc); indication of the highest and lowest rating received from any cohort of Raters; free-form comments submitted by all Raters; an executive summary report at the ‘Cluster’ level (self, other, work, etc); interpretation guide for all readers of report; contact details for those people who completed the report as Rater.

Storing of global demographic data on all Users, for later retrieval and manipulation so as to allow further analysis.

Populating a Global Demographic Report based on an operator defined series of selection criteria allowing comparison analysis of various demographic samples.

In one example, the employability skills assessment process resides in an apparatus for employability skills testing and reporting, comprising computer readable program code components configured to cause:

A database of generic employability skill for multiple market segments

A database of industry specific skills for multiple market segments

A method of storing, sorting, analysing and reporting on globally collected demographic data and individual User results.

In one example, the employability skills assessment process resides in a system for employability skills testing and reporting, the system comprising a data store in communication with a communication network for the purpose of storing, collating, sorting, analysing, retrieving and reporting the aforementioned data.

In one example, the employability skills assessment process resides in a graphical user interface for employability skills testing and reporting, the graphical user interface displaying:

User Report

Global Demographic Report

Searchable fields

A specific implementation of the employability skills assessment process will now be described in more detail with reference to FIGS. 7 to 17. For the purpose of this example, the assessee will be referred to as a user.

An example of an overall process will now be described with reference to FIG. 7.

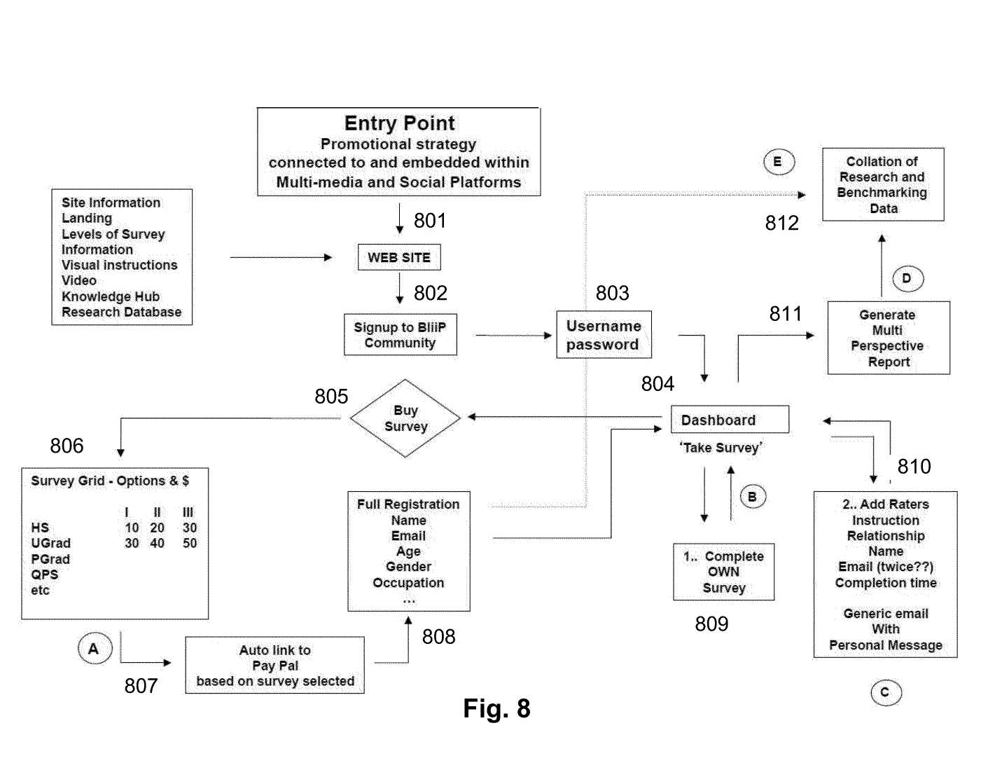

User directed to the web page 701 via multivariate integrated promotional avenues 702, whether that be via internet advertising, radio, television, word of mouth, endorsement by major employer or research companies 703, affiliate partners or collaborators 704, additional internal endorsements 705, social media ‘badges’ or URL directors from other sites 706, or the like. This is further explained in FIG. 8.

User engages with content of web page 701, through use of a computer system similar to that described above, wherein they will engage literature on the background and use of the process, research, and instructional guides whether that be in written, audio, video formats or the like.

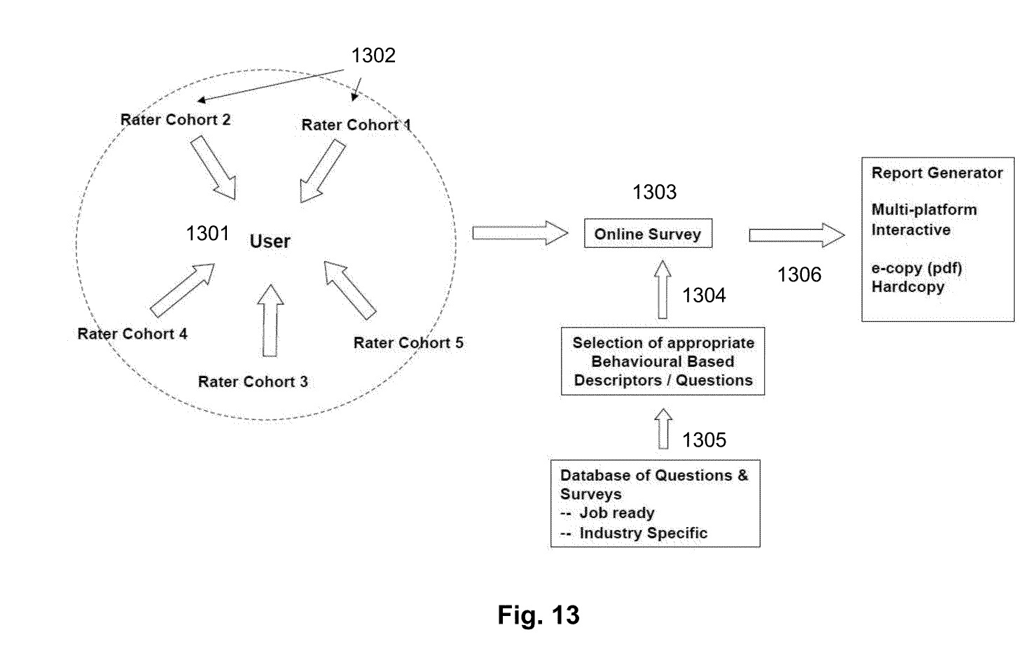

Through engaging and manipulation of web page(s) 701, User will access stored surveys 707, to generate Employability Skills Profiles 708 and 708a, based on multi-perspective feedback (FIG. 13) to pass to potential employers 712. This is further described in Figures below.

Through engagement, User will access real-time profile updates 709, allowing them to monitor and track their own feedback, real-time benchmarking 710, against globally collated data that can be sorted by multi-variate demographic filters, and research databases 711, providing supporting information into developing and enhancing employability skills.

Through engagement, User will also have access to development training and resources, advertised through a Geolocation training and development service, 713.

An example of the process from the assessee's perspective will now be described in more detail with reference to FIG. 8.

User enters website, 801 and chooses to sign-up to User Community 802 and creates unique username and password, and enters initial registration information including name, age, sex 803.

All User information is captured and added to database 812 (Further explained in below) for purpose of benchmarking, marketing and analytics.

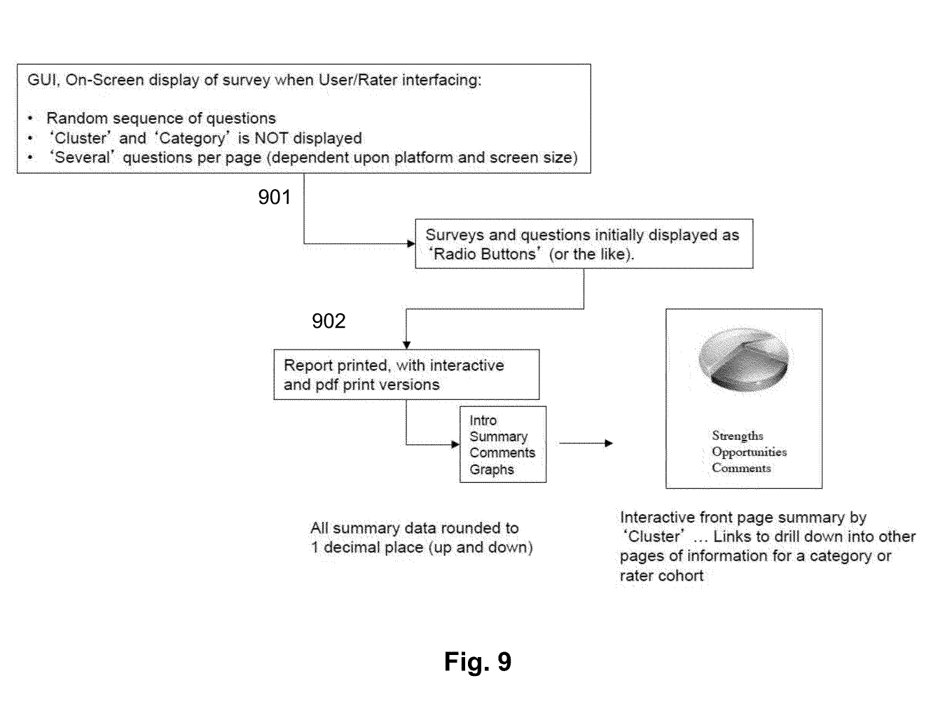

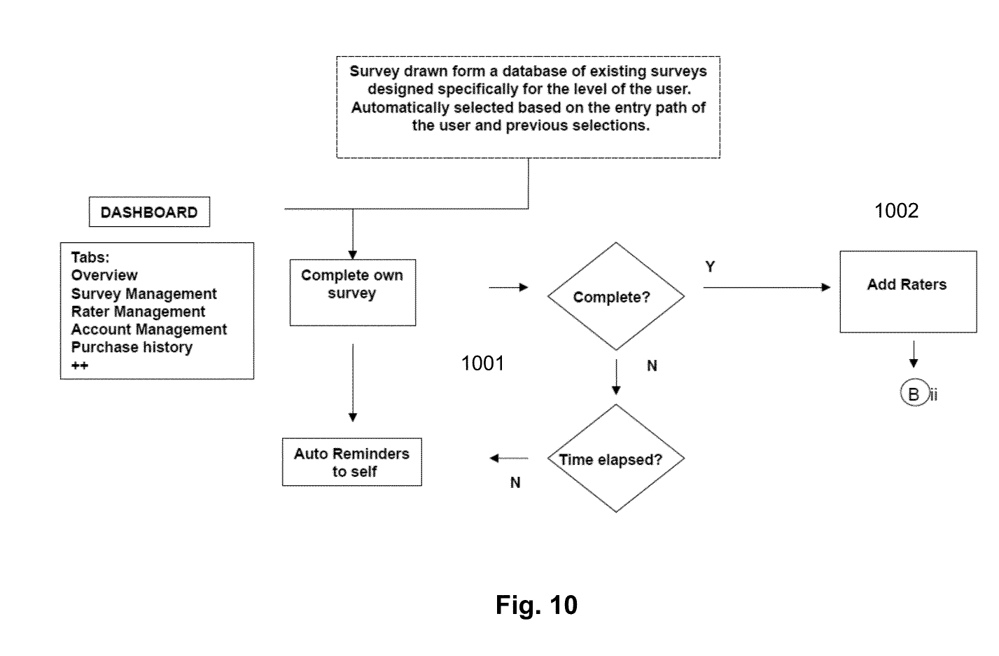

User engages a ‘Dashboard’ 804 (further explained in FIGS. 9, 10 and 11) that allows them to manage all facets of their user account including Personal Information, Purchases, Report tracking, Raters tracking and management, analysis of Benchmarking data.

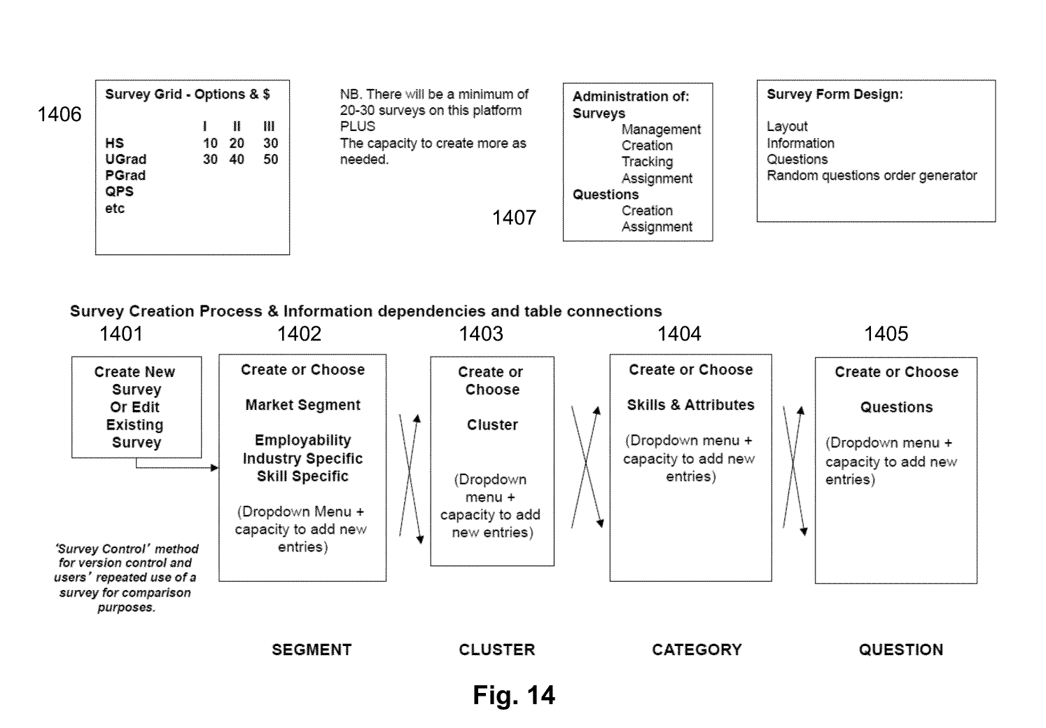

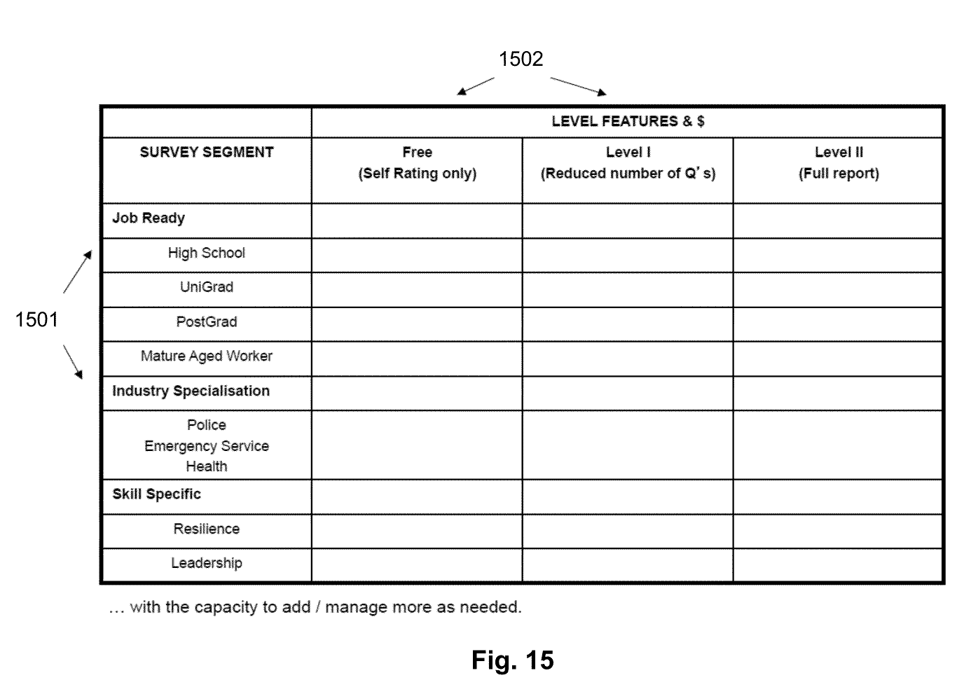

User decides to buy 805, an ‘Employability Skills’, ‘Industry Specific’ or ‘Skill Specific’ report process and is directed to a choice page 806 (further explained in FIGS. 14 and 15) to select appropriate survey/report based on a multitude of surveys/reports available.

User selects appropriate survey/report 806, and is automatically redirected to another webpage 807, for automatic payment of required amount.

User completes full registration data/demographics 808, including but not limited to occupation, industry, country, tenure, salary, date of birth, and targeted industries.

User returns to Dashboard 804 and selects to undertake own survey 809, a mandatory step prior to being able to engage other Raters in this process (further explained in FIG. 9).

The process of taking a survey will now be described in more detail with reference to FIG. 9. The system generates required Survey from database and tables of multivariate surveys (further explained in FIGS. 14 and 15).

User is redirected to Own Survey. Selection of Survey causes system to generate a GUI 901, displaying survey to User (or Rater). Although the survey is structured according a strict hierarchy of protocols and relationships, the method causes survey to be displayed as a random sequence of questions to the User (or Rater) to minimise the effect of patterning responses by the User (or Rater).

Once Survey is completed by both User and Raters, the User causes the method, by way of instruction, to generate Report 902. Report is generated by a specific algorithm designed to pull together multiple perspectives in such a way as to be fully structured with all random question inputs ordered into Clusters and Categories and sorted by Cohorts of Raters, to present a multi-perspective view of each cluster, category and question within the survey.

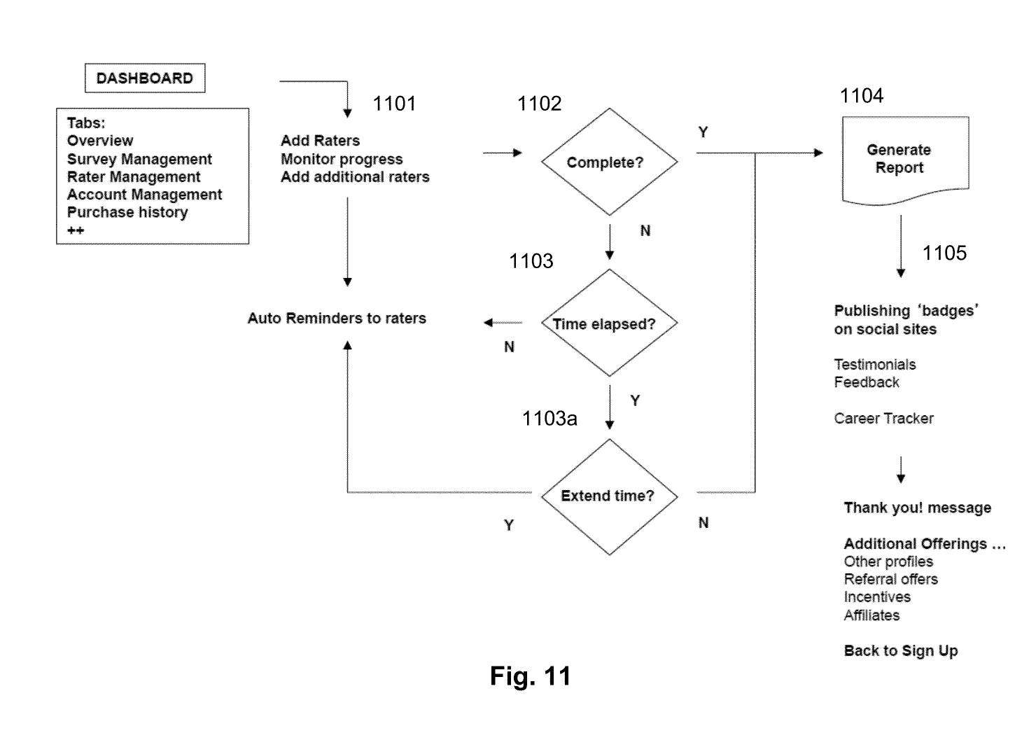

As shown in FIG. 10, the system 1001, monitors completion of User's own survey via Dashboard, generating automatic reminder notifications via email, to prompt User to complete own survey. Once complete, User adds Raters 1002, as also shown at 810 in FIG. 8.

The process of survey completion by raters is shown in more detail in FIG. 11.

User adds Raters 1101, triggering an invitational email to be automatically generated and sent to Raters. User uses Dashboard to monitor progress of Rater completion compared to User defined completion time.

The system 1102, automatically monitors completion rate of Raters' surveys. If approaching User defined completion time and the Rater has not yet completed, an automatic reminder notification is generated 1103 and forwarded to Rater via email.

User has option to extend time 1103a, if approaching completion date and Raters not yet complete.

When all Raters are completed or time has expired, User generates Report 1104 and as shown at 811 in FIG. 8, triggering creation of an interactive multi-media on-screen or hard copy report in pdf format or the like.

System then automatically generates a ‘badge’ (embedded hypertext link) 1105, for placement on social media sites and job boards (eg LinkedIn, SEEK, etc) or the like, and User is offered option to engage in further surveys based on outcomes from survey completed.

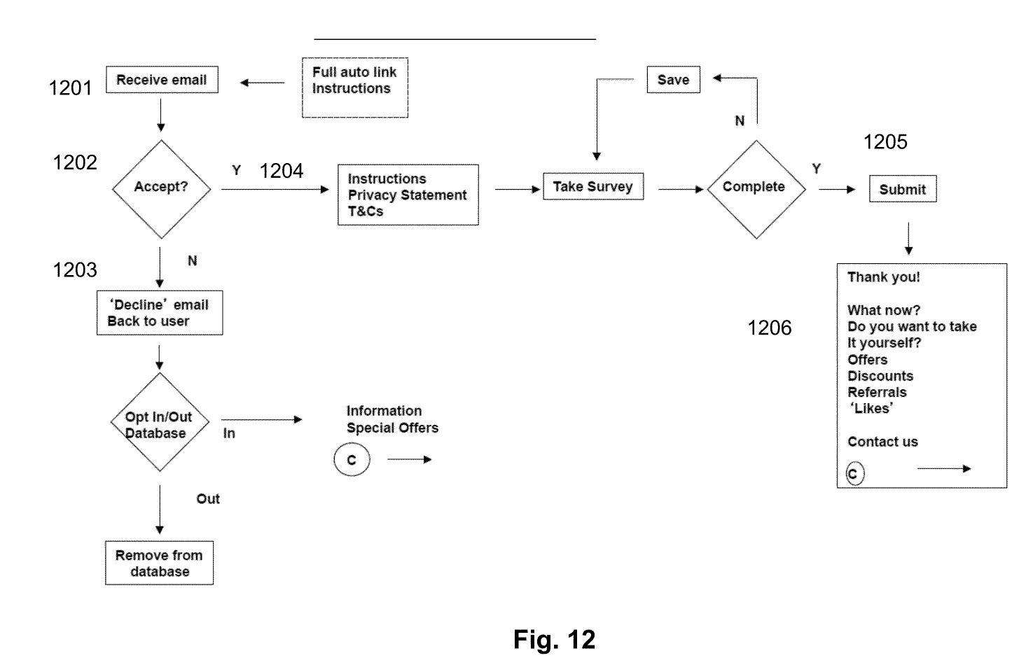

An example of the rater experience will now be described with reference to FIG. 12.

Rater receives automated email 1201, generated by User input, inviting Rater to be Rater for User. Rater chooses to accept or decline this invitation 1202, ‘yes’ or ‘no’.

If the Rater indicates via way of keystroke ‘no’, an automatically generated email 1203, is returned to the User Dashboard notifying of decision. Rater is then offered choice to ‘opt in’ or ‘opt out’ of System database records. Opting in to the database will trigger future notifications of offers for the Rater, until such time as the Rater opts out.

If the Rater indicates via way of keystroke ‘yes’, Rater is directed to instructions to undertake survey for User, 1204. Rater then undertakes survey and either ‘saves’, to come back and complete at a later time, or ‘submits’ 1205, to indicate to the system that Rater is complete, triggering Survey response to be added to the cumulative responses for User.

Once submitted 1205, the User is notified that the Rater has completed the survey. The Rater is then offered to join the System database 1206, and the Rater is offered to take up offer of competing survey for self as a User.

The approach of Multi-Perspective Feedback and the process of generating or administering a new survey will now be described with reference to FIGS. 13 to 15.

In this example, multi-perspective feedback is used in the following manner.

User 1301, seeks feedback from Rater Cohorts 1302. Rater Cohorts comprise one or more Raters from the same specified relationship with the User. By way of example, Rater Cohort 1, may consist of Family Members to User; Rater Cohort 2 may consist of Employers of User; Rater Cohort 3 may consist of Sporting Coaches of User; etc.

The User 1301, and each Rater within each Rater Cohort 1302, complete an online Survey 1303, generated from a database 1304, of selected behavioural descriptors and questions, drawn from a larger population database of behavioural descriptors and questions 1305. These questions from database 1305, are caused by way of User trigger (selection of appropriate Survey) to be organised through selection process 1304, into Survey 1303, in such a way that it is meaningful and appropriately structured to provide a complete Survey based on the User choice (as described above).

This method is further explained in FIG. 14. Upon completion of Survey 1303, Report Generator 1306, produces Report for interpretation and analysis by User (as further described in FIG. 9 above).

As shown in FIG. 14, survey data and information is stored in a database, for access based on User inputs and commands. This system is capable of holding an unlimited number of Surveys, each of which is constructed for a specific purpose and market segment.

A new Survey 1401, is generated for a particular Market Segment 1402, and consists of Clusters 1403, Categories 1404, and Behavioural Descriptors and Questions 1405.

Each survey consists of (drawn from Relational Tables and Databases in Apparatus and Method):

Segment 1402—A distinct market segment (also distinguished as product) requiring its own specialist, focused survey/questionnaire (as per list below).

Clusters 1403—A Superordinate Grouping of ‘Categories’ denoted as Self, Others, Work, Global Context, or the like.

Categories 1404—Specifically identified areas of skills and attributes (eg. Communication, Planning, etc).

Behavioural Descriptors/Questions 1405—A specific behavioural based question targeting a specific category (drawn from a database of known questions or from a new question created and added to the database).

Segments 1402, may include, but are by no means limited to:

Employability Skills—High School

Employability Skills—UnderGraduate

Employability Skills—PostGraduate

Specialist Industry—Emergency Services

Specialist industry—Police

Specialist Industry—Health

Skill Specific—Leadership

Skill Specific—Resilience

Skill Specific—Safety

Storage of each of the above elements is by way of the above described system and is managed via Survey Dashboard 1406, 1407.

FIG. 15 shows an example of complexity of management array for construction, storage and retrieval of surveys by Segment 1501, and Level of Report 1502.

This platform is also specifically designed to capture demographic information for the specific purpose of:

Generating benchmarking reports for comparison with User reports.

Collating global demographic data that can support further research and analysis of global trends in employability skills (BY GLOBAL RESEARCHERS)

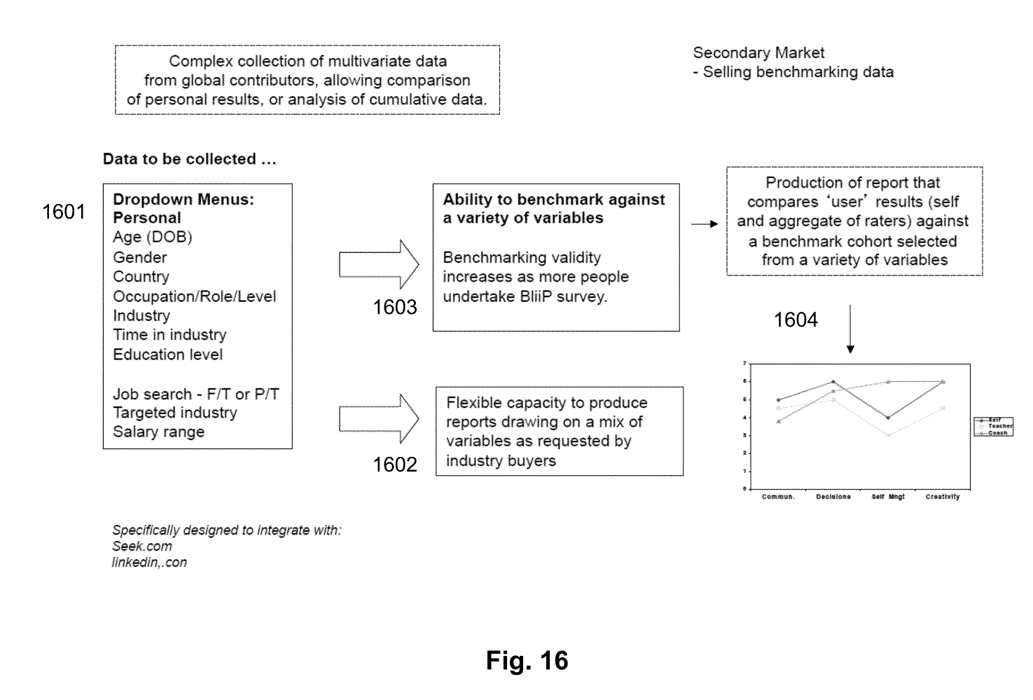

An example of this will now be described with reference to FIG. 16.

User demographic data 1601, is collected as described in FIG. 11. User demographic data is stored in a database, and retrieved via means of User or Administrator instructions 1602. These instructions consist of selection, via menu function on GUI, of multiple variables from the demographic data.

User results are then compared to selection data 1602, providing benchmarking 1603. User can elect to compare own results against any combination of demographic cohort within the system. Other Users are also able to access the information for purposes of research for normative data.

A report generator 1604, produces reports to compare User versus Benchmark data, or Benchmark Data in isolation.

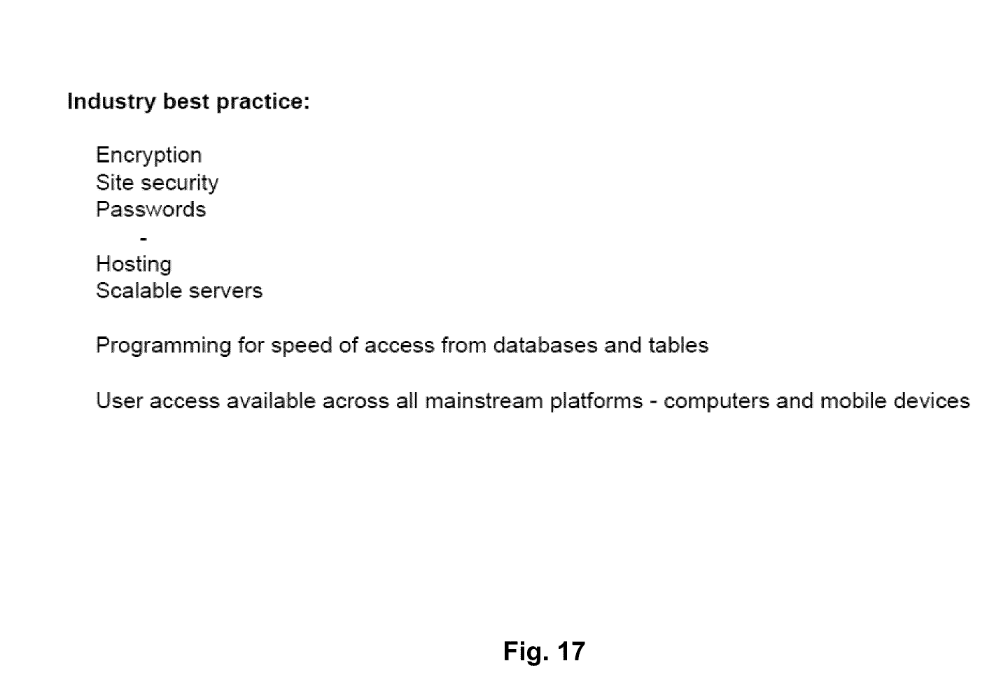

FIG. 17 is an example of security features of the above system.

Non functional features of this invention include Industry best practices in:

Encryption

Site security

Passwords

Hosting

Scalable servers

Programming for speed of access from databases and tables

User access available across all mainstream platforms—computers and mobile devices

Accordingly, in one example, the employability skills assessment process seeks to provide is an automated online globally deployable platform (method and apparatus) designed specifically for multi-perspective testing of potential job assessees against a set of internationally recognised employability skills criteria (for both general and industry specific skills), generating a multi-media personal report for posting on social and job platforms and for distribution to prospective employers.

In another example, the employability skills assessment process seeks to facilitate the multi-perspective assessment of students for the purpose of developing employability skills and to providing credible evidence of employability skills attainment for graduates to complement their academic and trade qualifications.

In another example, the employability skills assessment process seeks to facilitate the creation of employer generated profiles for job and industry specific roles, allowing a matching process to occur with a job applicant profile for improved recruitment processes and predictability of behaviours in the work place.

In another example, the employability skills assessment process seeks to facilitate capturing, analysing and reporting global benchmarking data for analysing cultural and other demographic information in employability skills.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

What is claimed is:

1. An Apparatus for use in performing an employability skills assessment for assessing employability skills of an assessee, the apparatus including an electronic processing device that:
a) identifies at least one rater in accordance with input commands from an assessee;
b) transfers a number of questions to the at least one rater via a communications network, the questions relating to employability skills of the assessee;
c) receives responses to the number of questions from the at least one rater via a communications network; and,
d) determines an employability skills rating at least partially using the responses, the employability skills rating being at least partially indicative of the assessee's employability skills.

2. The Apparatus according to claim 1, wherein the electronic processing device selects the number of questions from a plurality of predefined questions stored in a store.

3. The Apparatus according to claim 1, wherein the electronic processing device:
a) determines selection of at least one question category in accordance with input commands from an assessee; and,
b) selects the number of questions in accordance with the at least one question category.

4. The Apparatus according to claim 3 wherein the electronic processing device:
a) causes details of available surveys to be displayed to the assessee; and,
b) determines selection of an available survey in accordance with input commands from the assessee.

5. The Apparatus according to claim 1, wherein at least one question relates to at least one of:
a) skills of the assessee;
b) attributes of the assessee;
c) an industry;
d) a role for the assessee;
e) education of the assessee;
f) employability skills; and,
g) industry specific skills.

6. The Apparatus according to claim 1, wherein the electronic processing device:
a) transfers a number of questions to the assessee via a communications network;
b) receives responses to the number of questions from the assessee via a communications network; and,
c) determines an employability skills rating at least partially using the responses.

7. The Apparatus according to claim 1, wherein the electronic processing device generates an indication of the employability skills rating.

8. The Apparatus according to claim 1, wherein the electronic processing device provides the indication of the employability skills rating via a communications network.

9. The Apparatus according to claim 1, wherein the electronic processing device provides the indication of the employability skills rating to at least one of:
a) the assessee;
b) one or more raters;
c) a server of a social media network; and,
d) a potential assessor.

10. The Apparatus according to claim 1, wherein the electronic processing device:
a) determines at least one rating value for the assessee using the responses; and,
b) generates the indication of the employability skills rating at least partially in accordance with the rating value.

11. The Apparatus according to claim 10, wherein at least one of the questions includes a number of predetermined response options, each response option having a respective associated rating value, and wherein the electronic processing device determines the employability skills rating at least in part based on the selected response option and the associated rating value.

12. The Apparatus according to claim 1, wherein the employability skills rating is determined based on at least one of:
a) an average response of each rater;
b) a highest response of each rater;
c) a lowest response of each rater; and,
d) a response of each rater in a group of raters.

13. The Apparatus according to claim 1, wherein the raters are grouped according to a rater type, and wherein the method includes, in the electronic processing device, determining a respective employability skills rating for each group of raters.

14. The Apparatus according to claim 1, wherein the electronic processing device generates a report including at least one of:
a) the indication of the employability skills rating;
b) responses of at least one of the assessee and at least one rater;
c) a comparison of responses of the assessee and at least one rater;
d) a comparison of a first employability skills rating based on assessee responses and a second employability skills rating based on rater responses; and,
e) an indication of an identity of at least one rater.

15. The Apparatus according to claim 14, wherein the indication of the employability skills rating includes at least one of a graphical and an alphanumeric representation of at least one rating value.

16. The Apparatus according to claim 14, wherein the report includes an indicator displaying an employability skills rating for at least one of:
a) a cluster of categories; and,
b) a category.

17. The Apparatus according to claim 16, wherein the indicator includes at least one of:
a) a category indication identifying a respective category;
b) for each of a number of groups of raters:
i) a rater number identifying a number of raters in the respective group;
ii) a group identifier identifying the respective group;
iii) a first bar indicating the average rating of the respective group; and,
iv) a second bar highlighting the highest and lowest rating of the group; and,
c) an assessee rating.

18. The Apparatus according to claim 1, wherein the electronic processing device generates a reminder in the event that responses to the questions have not been received after a predetermined time interval.

19. The Apparatus according to claim 18, wherein the electronic processing device:
a) determines if responses have not been received from a rater after a predetermined number of reminders; and,
b) determines an alternative rater in accordance with input commands from the assessee.

20. The Apparatus according to claim 1, wherein for each rater the assessee provides contact details allowing the electronic processing device to transfer questions via the communications network.

21. The Apparatus according to claim 1, wherein the questions are grouped in categories and clusters of categories.

22. The Apparatus according to claim 21, wherein the clusters of categories include:
a) Personal Attributes;
b) Working with Others;
c) Achieving at Work;
d) Future Skills; and
e) Learning.

23. The Apparatus according to claim 22, wherein the personal attributes cluster includes categories relating to:
a) honesty/integrity;
b) social responsibility;
c) motivation/enthusiasm;
d) positive attitude;
e) resilience;
f) self-awareness/self-management;
g) reliability/responsibility;
h) autonomy/independence; and,
i) personal presentation.

24. The Apparatus according to claim 22, wherein the Working with Others cluster includes categories relating to:
a) communicating with others;
b) leading and influence;
c) respect for diversity;
d) team/group outcomes;
e) engaging networks;
f) connectivity/social intelligence; and
g) conflict resolution.

25. The Apparatus according to claim 22, wherein the Achieving at Work cluster includes categories relating to:
a) professionalism/work ethic;
b) customer service;
c) written communication;
d) numeracy;
e) using tools and technology;
f) critical thinking/problem solving;
g) understanding context of work;
h) working safely;
i) finding and managing information;
j) planning, organising and implementing; and,
k) delivering results.

26. The Apparatus according to claim 22, wherein the Future Skills cluster includes categories relating to:
a) technical competency;
b) media communication;
c) information analysis capabilities;
d) navigating trends and choices;
e) design mindset;
f) connection and collaboration;
g) being a global citizen;
h) personal mastery; and
i) career architect.

27. The Apparatus according to claim 22, wherein the Learning Skills cluster includes categories relating to:
a) learning at work;
b) adaptability;
c) flexibility; and
d) lifelong learning.

28. A method for use in performing an employability skills assessment for assessing employability skills of an assessee, the method including in an electronic processing device:
a) identifying at least one rater in accordance with input commands from an assessee;
b) transferring a number of questions to the at least one rater via a communications network, the questions relating to employability skills of the assessee;
c) receiving responses to the number of questions from the at least one rater via a communications network; and,
d) determining an employability skills rating at least partially using the responses, the employability skills rating being at least partially indicative of the assessee's employability skills.

29. A computer based method and apparatus for defining, standardising, and measuring multiple-perspectives and reporting on generic and industry specific employability skills of a potential employee for a potential employer.

30. A computer implemented method of an assessment of a job assessee, the assessment being against an electronic data store of a plurality of categories and questions for generic and industry specific employability skills, the method comprising of:
a) Storing in an electronic data store a plurality of questions designed to assess an assessees' generic and/or industry specific employability skills and attributes, with the questions created and stored based on a plurality of criteria including educational standing and industry;
b) Providing an assessee the option to choose a generic or industry specific questionnaire/survey, subsequently populated from the plurality of questions, subject to the assessee chosen educational and industry field;
c) Providing an assessee, via means of a computer based GUI, a series of randomly sequenced questions drawn from the electronic data store based on the assessee's choice of educational and industry level;
d) Providing an assessee a means, via GUI, of indicating their own self-assessment against the questions, for storing, recording and later recalling;
e) Providing an assessee a means of selecting a group of raters whom to gain feedback from, via a method of raters completing the same survey as the assessee, on the assessee, therein providing an external perspective of the assessees employability skills against the aforementioned questions;
f) Providing the raters with the same series of randomly generated questions as for the assessee, for them to independently answer;
g) Providing a means of generating a report in hard copy or multi-media format, that provides a comparison of answers between the assessee and the raters, grouped by cohorts of raters.

31. A method according to claim 30, wherein the plurality of different categories and questions relates to the specific skills and attributes of generic or industry specific employability.

32. The method according to claim 30, wherein the method includes having the assessee complete the assessment before the raters complete the assessment.

33. The method according to claim 30, wherein cohorts of raters comprise groupings of like relationships to the assessee for example but not limited to, family, employer, coach, manager, staff member.

34. The method according to claim 30, wherein upon completion, a report is generated that allows an assessee to assess their own answers against those of the raters.

35. The method according to claim 34, wherein a report is generated using quantifiers based upon calculations of:
a) an average of all responses of raters for each cohort;
b) a highest response for a given cohort of raters;
c) a lowest response for a given cohort of raters;
d) an average of all responses of raters for each cohort aggregated up to a level of clusters, a superordinate summation of all categories.

36. An apparatus for delivering an assessment to an assessee in accordance with the method any one of the claim 30, wherein the apparatus contains:
a) a display for visually displaying to the assessee each of the question types and requesting the assessee to indicate their answer to each question;
b) an input means for allowing the assessee to indicate their answers; and
c) a processor for driving the display and for being responsive to the input device for determining the answer provided by the assessee.

37. The computer and apparatus based method and apparatus for measuring and reporting on global generic and industry specific employability skills of a potential employee for a potential employer sorted by a plurality of demographic qualifiers collected through the accumulation, storage and retrieval of all responses from the sum total of all users/assessees and raters of the method of claim 30.
